(19) United States
(12) Patent Application Publication
(10) Pub. No.: US 2013/0330607 A1
(43) Pub. Date: Dec. 12, 2013

(54) ELECTROLYTIC SOLUTION AND LITHIUM-ION SECONDARY BATTERY

(71) Applicants: Kayo Mizuno, Kariya-shi (JP); Keiichi Hayashi, Kariya-shi (JP); Toshiki Inoue, Kariya-shi (JP); Osamu Ohmori, Kariya-shi (JP); Takayuki Hirose, Kariya-shi (JP); Yusuke Yamamoto, Kariya-shi (JP); Kohei Mase, Kariya-shi (JP); Masaaki Suzuki, Kariya-shi (JP)

(72) Inventors: Kayo Mizuno, Kariya-shi (JP); Keiichi Hayashi, Kariya-shi (JP); Toshiki Inoue, Kariya-shi (JP); Osamu Ohmori, Kariya-shi (JP); Takayuki Hirose, Kariya-shi (JP); Yusuke Yamamoto, Kariya-shi (JP); Kohei Mase, Kariya-shi (JP); Masaaki Suzuki, Kariya-shi (JP)

(73) Assignee: KABUSHIKI KAISHA TOYOTA JIDOSHOKKI, Kariya-shi, Aichi (JP)

(21) Appl. No.: 13/985,250

(22) PCT Filed: Feb. 16, 2012
(86) PCT No.: PCT/JP2012/001032

§ 371 Date: Aug. 13, 2013

(30) Foreign Application Priority Data
Feb. 17, 2011 (JP) 2011-031852
Jun. 29, 2011 (JP) 2011-144089
Jul. 1, 2011 (JP) 2011-147237
Jul. 6, 2011 (JP) 2011-149969
Jul. 6, 2011 (JP) 2011-150018
Jul. 7, 2011 (JP) 2011-150563
Jul. 7, 2011 (JP) 2011-150567
Aug. 5, 2011 (JP) 2011-171481
Aug. 5, 2011 (JP) 2011-171483

(51) Int. Cl. H01M 10/0567; H01M 10/0525

(52) U.S. Cl. CPC H01M 10/0567; H01M 10/0525
USPC 429/188

(57) ABSTRACT

In a lithium-ion secondary battery using a positive-electrode active material that includes a lithium-manganese-based oxide which includes a lithium (Li) element and a tetravalent manganese (Mn) element and whose crystal structure belongs to a layered rock-salt structure, adding a compound being selected from the group consisting of Compounds (a) through (i) into the electrolytic solution leads to the following: degradations due to oxidation-reduction decompositions of the electrolytic solution, and so on, are inhibited; and not only the shelf or storage capacity and recovered capacity upgrade in the case of being stored at high temperatures, but also the rise of internal resistance is inhibited.

### TECHNICAL FIELD

The present invention is one which relates to an electrolytic solution to be used for lithium-ion secondary battery, and the like, and to a lithium-ion secondary battery using that electrolytic solution.

### BACKGROUND ART

Recently, as being accompanied by the developments of portable electronic devices such as cellular phones and notebook-size personal computers, or as being accompanied by electric automobiles being put into practical use, and the like, small-sized, lightweight and high-capacity secondary batteries have been required. At present, as for high-capacity secondary batteries meeting these demands, lithium-ion secondary batteries have been commercialized, lithium-ion secondary batteries in which lithium cobaltate (e.g., LiCoO₂) and the carbon-based materials are used as the positive-electrode material and negative-electrode material, respectively. Since such a lithium-ion secondary battery exhibits a high energy density, and since it is possible to intend to make it downsize and lightweight, its employment as a power source has been attracting attention in a wide variety of fields. However, since LiCoO₂ is produced with use of Co, one of rare metals, as the raw material, it has been expected that its scarcity as the resource would grow worse from now on. In addition, since Co is expensive, and since its price fluctuates greatly, it has been desired to develop positive-electrode materials that are inexpensive as well as whose supply is stable.

Hence, it has been regarded promising to employ lithium-manganese-oxide-based composite oxides whose constituent elements are inexpensive in terms of the prices as well as which include stably-supplied manganese (Mn) in their essential compositions. Among them, a substance, namely, Li₂MnO₃ that comprises tetravalent manganese ions alone but does not include any trivalent manganese ions making a cause of the manganese elution upon charging and discharging, has been attracting attention. Although it has been believed so far that it is impossible to charge and discharge Li₂MnO₃, it has come to find out that it is possible to charge and discharge it by means of charging it up to 4.8 V, according to recent studies.

Moreover, as one of the lithium-manganese-oxide-based composite oxides that include tetravalent manganese ions alone but do not include any trivalent manganese ions, xLi₂MnO₃.(1−x)LiMeO₂ (where 0<“x”≦1), one of solid solutions between Li₂MnO₃ and LiMeO₂ (where “Me” is a transition metal element), has also been developed. Note that it is feasible to write and express Li₂MnO₃ by a general formula, Li(Li_{0.33}Mn_{0.67})O₂, as well, and that it is said to belong to the same crystal structure as that of LiMeO₂. Consequently, there arises a case where xLi₂MnO₃.(1−x)LiMeO₂ is set forth as Li_{1.33-y}Mn_{0.67-z}Me_{y+z}O₂ (where 0≦“y”<0.33, and 0≦“z”<0.67), too.

This lithium-manganese-oxide based composite oxide is excellent in terms of charging and discharging characteristics, compared with those of the above-described Li₂MnO₃. Hereinafter, lithium-manganese-oxide-based composite oxides, which include tetravalent manganese ions alone but do not include any trivalent manganese ions like this, will be simply abbreviated to as “lithium-manganese-based composite oxides.” The crystal structure of these lithium-manganese-based composite oxides is a structure that is called a “layered rock-salt structure.”

Incidentally, prior to the employment of lithium-ion secondary batteries in which a lithium-manganese-oxide-based composite oxide including tetravalent manganese ions is used as the positive-electrode active material, it is necessary to activate the positive-electrode active material by charging the lithium-ion secondary batteries. In this activation step, there has been such a phenomenon that not only lithium ions are released from the lithium-manganese-oxide-based positive-electrode active material, but also oxygen eliminates, and the electrolytic solution is oxidized to decompose by means of that oxygen. Moreover, there has been such another phenomenon that, even when storing the lithium-ion secondary batteries under the charged condition during high-temperature storage tests, the electrolytic solution decomposes at the positive-electrode surface. When the electrolytic solution is thus oxidized to decompose, insulating coatings are formed onto the electrode surface, so that the internal resistance becomes higher; and thereby there has been such a problem that the post-storage charging and discharging capacities lower.

Moreover, in lithium-ion secondary batteries in which carbonaceous materials, such as graphite, are used as the negative-electrode active material, the solvent within the electrolytic solution is reduced to decompose on the negative-electrode surface at the time of charging, so that insulating coatings, which are referred to as “SEI” (i.e., Solid Electrolyte Interface), are formed onto the negative electrode's surface. This “SEI” has come to result in an irreversible capacity, because LiF or LiCO₃, and the like, is the major component, and because these are irreversible substances so that utilizable lithium amounts for charging and discharging have decreased.

Patent Literature No. 1 sets forth the following: in a lithium-ion secondary battery in which LiMn₂O₄, or the like, is used as the positive-electrode active material, adding a sultone compound to the electrolytic solution; and, by means of the addition of a sultone compound, the cyclability improves, because the dissolution of manganese from the positive-electrode active material is inhibited, and moreover because the decomposition of the electrolytic solution at the negative-electrode surface is inhibited.

Patent Literature No. 2 sets forth the following: in a lithium-ion secondary battery in which a spinel compound, such as LiNi_{0.5}Mn_{1.5}O₄, is used as the positive-electrode active material, adding a sultone compound to the electrolytic solution; and the charging and discharging characteristics are improved by means of the addition of a sultone compound.

Patent Literature No. 3 sets forth to add a sulfuric-acid-ester compound and a triply-bonded compound to an electrolytic solution in order to prevent oxidation-reduction decompositions.

However, in Patent Literature Nos. 1 through 3 that have been aforementioned, those using such a positive-electrode active material that causes oxygen to generate by means of activation treatment are not present at all, so that it has been difficult to inhibit the decomposition of electrolytic solution at the positive-electrode surface using a positive-electrode active material like this. Moreover, since the negative-electrode active material also uses a carbonaceous material such as graphite, degradations resulting from the generation of SEI are inevitable.

Patent Literature No. 4 sets forth the following: adding unsaturated lactones to the electrolytic solution of lithium-ion secondary battery; and it is possible to inhibit oxidation decompositions of the major solvent, because the unsaturated lactones decompose on the positive electrode to form protective coatings.

Patent Literature No. 5 sets forth the following: adding a compound having a lactone ring to the electrolytic solution of lithium-ion secondary battery; and doing so leads to inhibiting decomposition reactions of the electrolytic solution so that the stability upgrades.

However, in Patent Literature Nos. 4 and 5 that have been aforementioned, those using such a positive-electrode active material that causes oxygen to generate by means of activation treatment are not present at all, so that it has been difficult to inhibit the decomposition of electrolytic solution and so on at the positive-electrode surface using a positive-electrode active material like this.

Patent Literature No. 6 sets forth the following: in a lithium-ion secondary battery in which LiMn₂O₄ or LiMnO₂, and the like, is used as the positive-electrode active material, adding thiophene to the electrolytic solution; and the resulting protective film on the negative-electrode surface is made finer and denser by means of the addition of thiophene so that it is possible to make the negative electrode's interface impedance lower.

Patent Literature No. 7 sets forth the following: a coating is formed onto a negative-electrode surface by adding thiophene to the electrolytic solution of lithium-ion secondary battery, and thereby irreversible reactions that occur between the negative electrode and an electrolyte can be prevented.

Patent Literature No. 8 sets forth the following: in a lithium-ion secondary battery in which LiMn₂O₄, or the like, is used as the positive-electrode active material, adding thiophene to the electrolytic solution; and a coating is formed onto the positive electrode by means of the addition of thiophene, so that it is possible to prevent transition metals, such as Mn, from eluting out from the positive electrode into the electrolytic solution.

However, in Patent Literature Nos. 6 through 8 that have been aforementioned, those using such a positive-electrode active material that causes oxygen to generate by means of activation treatment are not present at all, so that it has been difficult to inhibit the decomposition of electrolytic solution and so on in the positive-electrode surface using a positive-electrode active material like this. Moreover, since the negative-electrode active material also uses a carbonaceous material such as graphite, degradations resulting from the generation of SEI are inevitable.

Patent Literature No. 9 discloses such a technique that an aromatic compound is further compounded with an electrolytic solution including fluoroethylene carbonate (e.g., 4-fluoro-1,3-dioxolane-2-one). As specific examples of the aromatic compound, the following are given: benzene derivatives, biphenyl derivatives, cycloalkylbenzene derivatives, dibenzofuran, dibenzofuran derivatives, terphenyl, compounds being made by hydrogenating a part of terphenyl, diphenyl ether, diphenyl ether derivatives, xylene derivatives, anisole derivatives, dimethoxybenzene, dimethoxybenzene derivatives, phenoxyethoxybenzene, phenoxyethoxybenzene derivatives, diphenoxybenzene, diphenoxybenzene derivatives, diphenylalkane, diphenylalkane derivatives, tert-alkylbenzene, and iso-alkylbenzene.

Patent Literature No. 9 sets forth that using fluoroethylene carbonate and the above-mentioned aromatic compound combindely leads to making it possible to upgrade the high-temperature characteristics (e.g., the high-temperature preservation characteristic, and so forth) of electrolytic solution in lithium-ion secondary battery.

However, since those being exemplified as the positive-electrode active material in Patent Literature No. 9 are conventional type composite oxides that include lithium and transition metal elements, such as lithium-cobalt composite oxides (e.g., LiₓCoO₂), nothing is disclosed at all as to any composition of the electrolytic solution in a case where the above-mentioned lithium-manganese-based composite oxide is used as the positive-electrode active material.

Patent Literature No. 10 sets forth the following: in a lithium-ion secondary battery in which LiMn₂O₄ or LiMnO₂, and the like, is used as the positive-electrode active material, using 1-methylpyrole, 2-methylpyrole or 3-methylpyrole, and so on, for the electrolytic solution; and it is possible to lower the content of hydroxy carboxylic acid by doing so.

Patent Literature No. 11 sets forth the following: in a lithium-ion secondary battery in which LiMn₂O₄, or the like, is used as the positive-electrode active material, since a coating is formed onto a positive electrode by adding methylpyrole, which is oxidized at a low electric potential, to the electrolytic solution, the overcharge performance upgrades.

Patent Literature No. 12 sets forth the following: adding N-methylpyrole to an electrolytic solution; and a coating is formed onto a positive electrode by means of that addition, so that it is possible to inhibit dangerous situations at the time of overcharging.

Patent Literature No. 13 sets forth the following: adding γ-butyrolactone in an amount of 0.5% by mass or more, along with halogenated cyclic carboxylic ester, to the electrolytic solution of lithium-ion secondary battery; and, without using any divinyl sulfone at all, it is possible to inhibit the swelling deformations of battery at the time of high-temperature preservations by means of the addition of γ-butyrolactone.

Patent Literature No. 14 sets forth the following: adding γ-butyrolactone in an amount of from 5 to 15% by volume, as well as halogenated toluene, to the electrolytic solution of lithium-ion secondary battery leads to being of superb overcharge characteristic, and to also upgrading high-temperature characteristics.

Patent Literature No. 15 sets forth to add γ-butyrolactone in an amount of from 1 to 50% by volume, as well as a wettability activating agent, to the electrolytic solution of lithium-ion secondary battery. It is possible to make the viscosity of γ-butyrolactone lower by adding a wettability activating agent, and thereby the resulting longevity characteristic and safety upgrade.

However, in Patent Literature Nos. 10 through 15 that have been aforementioned, those using such a positive-electrode active material that causes oxygen to generate by means of activation treatment are not present at all, so that it has been difficult to inhibit the decomposition of electrolytic solution and so on in the positive-electrode surface using a positive-electrode active material like this. Moreover, since the negative-electrode active material also uses a carbonaceous material such as graphite, degradations resulting from the generation of SEI are inevitable.

Patent Literature No. 16 sets forth the following: in a lithium-ion secondary battery in which LiMn₂O₄ or LiMnO₂, and the like, is used as the positive-electrode active material, adding furan to the electrolytic solution; and the resulting protective film on the negative-electrode surface is made finer and denser by means of the addition of furan so that it is possible to make the negative electrode's interface impedance lower.

Patent Literature No. 17 sets forth the following: adding furan to the electrolytic solution of lithium-ion secondary battery leads to making it possible to quickly shut off electric currents, because the additive agent polymerizes to form a coating on the positive electrode and accordingly heat generations occur due to the rise in the internal resistance of the resulting battery, when the battery has come to be overcharged; and consequently it is possible to materialize safe batteries, because it is possible to prevent the lowering of the thermal stability of the positive-electrode active material, too.

In Patent Literature No. 16 that has been aforementioned, however, those using such a positive-electrode active material that causes oxygen to generate by means of activation treatment are not present at all, so that it has been difficult to inhibit the decomposition of electrolytic solution and so on at the positive-electrode surface using a positive-electrode active material like this. Moreover, in Patent Literature No. 17, degradations resulting from the generation of SEI are inevitable, because the negative-electrode active material also uses a carbonaceous material such as graphite and no description is available with regard to such a problem as the lowering of charging and discharging capacities after storage under the condition of being fully charged.

Patent Literature No. 18 discloses the following technique: in a lithium-ion secondary battery, overcharging is inhibited by means of compounding a redox shuttle additive agent and a radical-polymerization additive agent into an electrolyte. To be concrete, the radical-polymerization additive agent is polymerized by means of oxidizing substances that have arisen from the redox shuttle additive agent, and thereby the lithium-ion secondary battery is shut down at the time of being overcharged. As for the redox shuttle additive agent, reaction products of fluorinated dodecaborate electrolyte salt, and the like, are given. As for the radical-polymerization additive agent, biphenyl, cyclohexylbenzene, substituted benzene, and so forth, are given.

Patent Literature No. 18 sets forth that it is possible to shut down a lithium-ion secondary battery at the time of being overcharged by means of a synergistic effect that results from using a redox shuttle additive agent and a radical-polymerization additive agent combinedly.

However, in Patent Literature No. 18, those being exemplified as the positive-electrode active material are a conventional type composite oxide including lithium and a transition metal element, such as lithium-cobalt composite oxide (e.g., LₓCoO₂); and accordingly nothing is disclosed at all as to any composition of the electrolytic solution in a case where the above-mentioned lithium-manganese-based compound is used as the positive-electrode active material.

Patent Literature No. 19 discloses the following techniques: in a non-aqueous-electrolyte secondary battery, an explosion prevention valve is disposed in the battery; and additionally an additive agent comprising diphenyl disulfide or its derivatives is compounded into the electrolytic solution.

Patent Literature No. 19 sets forth that it is possible to inhibit the non-aqueous-electrolyte secondary battery from igniting and bursting during the time of being overcharged and so on by having diphenyl disulfide or its derivatives contained into the electrolyte. As one of its reasons, it sets forth that a coating, which is based on diphenyl disulfide or its derivatives, is formed onto the positive-electrode surface at the time of the occurrence of abnormalities, such as overcharging, and thereby impedance rises so that the reactions between the positive electrode or negative electrode and the electrolyte are inhibited. Moreover, as another reason, it sets forth the following: being accompanied by rise in the impedance, heat generations occur; accordingly gases are generated by means of the decompositions of diphenyl disulfide or its derivatives; and consequently inner pressure of the battery rises in a short period of time; as a result, the explosion prevention valve operates early on so that turning on electricity inside the battery is shut off.

However, in Patent Literature No. 19, no disclosure is made at all as to any technique for using an additive agent for the purpose of other than causing the explosion prevention valve to operate (for example, for the purpose of inhibiting the lowering of post-storage charging discharging capacities) in lithium-ion secondary batteries that are free from the explosion prevention valve. Moreover, in Patent Literature No. 19, one being exemplified as the positive-electrode active material is a conventional type composite oxide including lithium and a transition metal element, such as lithium-cobalt composite oxide (e.g., LₓCoO₂); and accordingly no disclosure is made at all as to any composition of the electrolytic solution in a case where the above-mentioned lithium-manganese-based composite oxide is used as the positive-electrode active material.

### RELATED TECHNICAL LITERATURE

### Patent Literature

Patent Literature No. 1: Japanese Unexamined Patent Publication (KOKAI) Gazette No. 11-339850;
Patent Literature No. 2: Japanese Unexamined Patent Publication (KOKAI) Gazette No. 2005-149750;
Patent Literature No. 3: International Publication No. WO/2005/117197;
Patent Literature No. 4: Japanese Unexamined Patent Publication (KOKAI) Gazette No. 2005-285504;
Patent Literature No. 5: Japanese Unexamined Patent Publication (KOKAI) Gazette No. 2006-318761;
Patent Literature No. 6: Japanese Unexamined Patent Publication (KOKAI) Gazette No. 2002-184462;
Patent Literature No. 7: Japanese Unexamined Patent Publication (KOKAI) Gazette No. 2002-008720;
Patent Literature No. 8: Japanese Unexamined Patent Publication (KOKAI) Gazette No. 2000-090970;
Patent Literature No. 9: Japanese Unexamined Patent Publication (KOKAI) Gazette No. 2006-309965;
Patent Literature No. 10: Japanese Unexamined Patent Publication (KOKAI) Gazette No. 2003-092137;
Patent Literature No. 11: Japanese Unexamined Patent Publication (KOKAI) Gazette No. 2010-219058;
Patent Literature No. 12: Japanese Unexamined Patent Publication (KOKAI) Gazette No. 2002-270223;
Patent Literature No. 13: Japanese Unexamined Patent Publication (KOKAI) Gazette No. 2008-192391;
Patent Literature No. 14: Japanese Unexamined Patent Publication (KOKAI) Gazette No. 2006-108100;
Patent Literature No. 15: Japanese Unexamined Patent Publication (KOKAI) Gazette No. 2006-108092;
Patent Literature No. 16: Japanese Unexamined Patent Publication (KOKAI) Gazette No. 2002-184462;
Patent Literature No. 17: International Publication No. WO/2002/054524;
Patent Literature No. 18: Japanese Unexamined Patent Publication (KOKAI) Gazette No. 2010-520610; and
Patent Literature No. 19: Japanese Unexamined Patent Publication (KOKAI) Gazette No. 2010-186751

### SUMMARY OF THE INVENTION

### Assignment to be Solved by the Invention

The present invention is one which has been done in view of such circumstances. It is therefore an assignment to be solved not only to inhibit the degradations of electrolytic solution, but also to inhibit the lowering of charging and discharging capacities even after storage, in a lithium-ion secondary in which a lithium-manganese-based composite oxide demonstrating high capacities but requiring some activation treatment is used as the positive electrode active material.

### Means for Solving the Assignment

Characteristics of an electrolytic solution according to the present invention solving the aforementioned assignment lie in that the electrolytic solution is used for lithium-ion secondary battery being provided with a positive electrode that has a positive-electrode active material comprising a lithium-manganese-based oxide which includes a lithium (Li) element and a tetravalent manganese (Mn) element and whose crystal structure belongs to a layered rock-salt structure, and includes an additive agent comprising at least one member of compounds that is selected from the group consisting of Compounds (a) through (i).

Moreover, a characteristic of a lithium-ion secondary battery according to the present invention using the electrolytic solution according to the present invention lies in that the lithium-ion secondary battery comprises:

a positive electrode having a positive-electrode active material that comprises a lithium-manganese-based oxide which includes a lithium (Li) element and a tetravalent manganese (Mn) element and whose crystal structure belongs to a layered rock-salt structure;

a negative electrode; and

the electrolytic solution according to the present invention.

### Effect of the Invention

The electrolytic solution according to the present invention includes an additive agent comprising at least one member of compounds that is selected from the group consisting of Compound (a) through Compound (i). This additive agent exhibits an “HOMO” that is greater than that of organic solvents having been used commonly as electrolytic solutions so that it is likely to be oxidized, or exhibits an “LUMO” that is smaller than that of organic solvents so that it is likely to be reduced. Consequently, it is believed that, at the time of activation treatment and during high-temperature storage, the additive agent is decomposed more preferentially than is major components of the electrolytic solution, so that it forms a stable coating on the positive-electrode active material comprising a lithium-manganese-based oxide that belongs to a layered rock-salt structure.

Carbonaceous materials, such as graphite (e.g., “MAG”) that has been used commonly as a negative-electrode active material, possess an area, which is called as an edge face, on the surface. It is believed that, though the edge face makes an inlet for the insertion and elimination of lithium, it contrarily contributes to the reductive decompositions of electrolytic solution at the time of charging. By means of these reductive decompositions of electrolytic solution, an insulating coating, which is referred to as an “SEI” (i.e., Solid Electrolyte Interface), is formed on a negative-electrode surface. The “SEI” has LiF or LiCO₃, and the like, as the major component. Since the reaction in which LiF or LiCO₃ occurs from Li and electrolytic solutions is an irreversible reaction, Li inside batteries is lost irreversibly by means of this reaction. Consequently, a lithium amount, which is utilizable for charging and discharging, is decreased by means of the generation of “SEI,” and thereby there might possibly arise such a case that an irreversible capacity occurs.

In a case where a silicon oxide being expressed by SiOₓ (where 0.3≦“x”≦1.6) (hereinafter, being simply abbreviated to as “SiOₓ”) is used as a negative-electrode active material in the lithium-ion secondary battery according to the present invention, it is possible to inhibit the reductive decompositions of the electrolytic solution furthermore, because SiOₓ is does not possess any edge face as “MAG” does.

As a result of inhibiting the electrolytic solution from being decomposed, not only the resulting conserved capacity and recovered capacity augment but also a rise in the resistance is inhibited at the time of storage, so that the storage characteristics of the resultant lithium-ion secondary battery upgrade.

### BRIEF DESCRIPTION OF THE DRAWINGS

FIG. 1 is graph that illustrates a relationship between conserved capacities and addition amounts of 2,3-butanediol-dimethanesulfonate within an electrolytic solution;

FIG. 2 is graph that illustrates a relationship between recovered capacities and addition amounts of 2,3-butanediol-dimethanesulfonate within an electrolytic solution; and

FIG. 3 is graph that illustrates a relationship between rates of rise in internal-resistance and addition amounts of 2,3-butanediol-dimethanesulfonate within an electrolytic solution.

### MODE FOR CARRYING OUT THE INVENTION

### Compound (a)

Compound (a) is a chain-shaped compound having a sultone group. As for the chain-shaped compound having a sultone group, it is possible to use at least one member that is selected from the group consisting of the following: 2,3-butanediol-dimethanesulfonate, 2-methylene-1,4-butanediol-ditosylate, 2-methylene-1,4-butanediol-1-tosylate-4(methane-sulfonate), 2-methylene-1,4-butanediol-bis(methanesulfonate), 2-methylene-1,4-butanediol-1-(methanesulfonate)-4-tosylate, 1,4-butanediol-dimethanesulfonate (or “Busulfan,” another name), 2,2,3,3-tetrafluoro-1,4-butanediol-bis (hydrogen sulfate), 2,2,3,3-tetrafluoro-1,4-butanediol-bis (sulfuric acid trimethylsilyl), (1R,2R,3R)-1-(4-methylphenyl)-2-(tosylmethyl)-1,3-butanediol, and 4-(tosyloxy)-1-butanol, for instance.

A concentration of Compound (a) within the electrolytic solution depends on the types of Compound (a). In a case where Compound (a) has a sultone group in a quantity of two like 2,3-butanediol-dimethanesulfonate, it is desirable to set the concentration to fall in a range of from 0.5% by mass to 1.0% by mass. The concentration of Compound (a) being less than 0.5% by mass makes it difficult to demonstrate the added effects, whereas exceeding 1.0% by mass is not preferable not only because the effects lower but also because the internal resistance of the resulting lithium-ion secondary battery rises.

### Compound (b)

Compound (b) includes an oxygen-containing heterocyclic ring, a carbonyl group being formed onto one of carbon atoms lying adjacent to an oxygen atom in the oxygen-containing heterocyclic ring, and a carboxyl group being bonded onto another one of carbon atoms lying adjacent to the oxygen atom in the oxygen-containing heterocyclic ring directly or by way of an alkyl group.

As for this Compound (b), it is possible to select one of the following to use: -pyrone-6-carboxylic acid, 4-pyrone-2-carboxylic acid, 2-pyrone-4,6-dicarboxylic acid being specified in Chemical Formula 2, 4-pyrone-2,6-dicarboxylic acid, or 3-caroboxy muconolactone being specified in Chemical Formula 3; alternatively, those in which an alkyl group, nitro group or amino group, and the like, substitutes for the carboxyl group at the fourth position in 2-pyrone-4,6-dicarboxylic acid, or those in which a carboxyl ester substitutes for the fourth position.

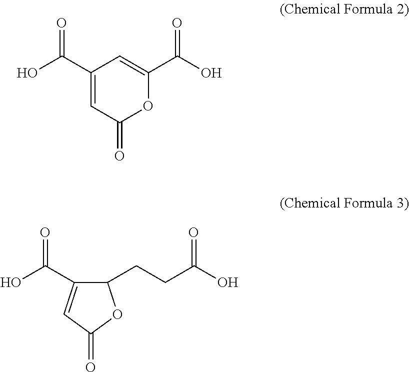 [SMILES: O=C(O)c1cc(C(=O)O)oc(=O)c1 ; O=C(O)CCC1OC(=O)C=C1C(=O)O]

Note that it is necessary to dissolve this Compound (b) into an organic solvent, and that it should be avoided as well to add it beyond the solubility. Although an addition amount of Compound (b) within the electrolytic solution depends on the types of Compound (b) and organic solvent, it is desirable to set the addition amount to fall in a range of from 0.05% by mass to less than 2.0% by mass. Compound (b) being less than 0.05% by mass makes it difficult to demonstrate the added effects, whereas becoming 2.0% by mass or more is not preferable not only because the effects lower but also because the internal resistance of the resulting lithium-ion secondary battery rises.

Note that the calculated values of “HOMO” and “LUMO” energies for representative Compounds (b) and organic solvents are given in Table 1. The calculating method was carried out based on “AM1.”

TABLE 1

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| 2-Pyrone-4,6-Dicarboxylic Acid | −9.59 | −0.77 |
| 3-Caroboxy Muconolactone | −11.22 | 1.00 |

Since Compounds (b) exhibit small “HOMO” absolute values, and since they also exhibit small “LUMO” absolute values, compared with those of the organic solvents, it is understood that, at the time of charging, they are likely to be oxidized on a positive electrode and are likely to be reduced on a negative electrode.

### Compound (c)

Compound (c) is one which is selected from the group consisting of thiophene and thiophene derivatives. As for the thiophene derivatives, it is possible to select one of the following to use: 3-methylthiophene, 3-ethylthiophene, 3-proplythiophene, 3-buthylthiophene, 3-penthylthiophene, 3-hexylthiophene, 3-hepthylthiophene, 3-n-octylthiophene, 3-nonylthiophene, 3-decylthiophene, 3-undecylthiophene, 3-dodecylthiophene, 3-octadecylthiophene, 2-acetylthiophene, 2-acetyl-3-methylthiophene, 2-acetyl-5-methylthiophene, 2,3-dimethylthiophene, 2,5-dimethylthiophene, 2-bromo-3-methylthiophene, ethyl 3-methylthiophene acetate, 3-methyl-2-thiophene carboxylic acid, ethyl 2-amino-4,5-dimethyl-3-thiophene carboxylate, 2-nitrothiophene, 2,3-dinitrothiophene, and 3-aminothiophene.

Note that it is necessary to dissolve this Compound (c) into an organic solvent, and that it should be avoided as well to add it beyond the solubility. Although an addition amount of Compound (c) within the electrolytic solution depends on the types of Compound (c) and organic solvent, it is desirable to set the addition amount to fall in a range of from 0.01% by mass to less than 2.0% by mass. Compound (c) being less than 0.01% by mass makes it difficult to demonstrate the added effects, whereas becoming 2.0% by mass or more is not preferable not only because the effects lower but also because the internal resistance of the resulting lithium-ion secondary battery rises.

Note that the calculated values of “HOMO” and “LUMO” energies for representative Compounds (c) and organic solvents are given in Table 2. The calculating method was carried out based on “AM1.”

TABLE 2

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| Thiophene | −9.22 | 0.24 |
| 2-Nitrothiophene | −8.14 | 0.56 |
| 3-Nitrothiophene | −7.92 | 0.49 |

Since Compounds (c) exhibit small “HOMO” absolute values, and since they also exhibit small “LUMO” absolute values, compared with those of the organic solvents, it is understood that, at the time of charging, they are likely to be oxidized on a positive electrode and are likely to be reduced on a negative electrode.

### Compound (d)

Compound (d) is at least one member that is selected from the group consisting of tert-alkylbenzene and tert-alkylbenzene derivatives. The “tert-alkylbenzene” is one in which a tert-alkyl group (or being said to be a “tertiary” alkyl group as well) is bonded onto benzene. Representative one is tert-butylbenzene being specified in Chemical Formula 4, or tert-pentylbenzene (or being also called tert-amylbenzene as well) being specified in Chemical Formula 5.

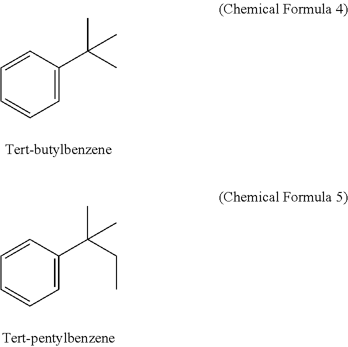

In accordance with the lithium-ion secondary battery according to the present invention, it is possible to inhibit decompositions of the electrolytic solution by adding Compound (d) to the electrolytic solution. Although its reason has not been apparent yet, it is believed to result from “Redox Shuttle.” “Redox” (i.e., Reduction/oxidation) is about oxidation-reduction reactions. It is believed that, in the state of being dissolved in solvents or liquid dispersion media, Compound (d) functions as a “Redox Shuttle” that is oxidized preferentially on a positive electrode and is reduced preferentially on a negative electrode, so that it inhibits decompositions of the electrolytic solution at the positive electrode and negative electrode. And, it is believed that Compound (d) inhibits troubles, which are caused by decompositions of the electrolytic solution, in the formation of insulating film, and so on, thereby inhibiting the post-storage charging and discharging capacities from lowering.

As for specific examples of tert-alkylbenzene and its derivatives, the following can be given: tert-butylbenzene, 1-fluoro-4-tert-butylbenzene, 1-chloro-4-tert-butylbenzene, 1-bromo-4-tert-butylbenzene, 1-iodo-4-tert-butylbenzene, 5-tert-butyl-m-xylene, 5-tert-butyltoluene, 3,5-di-tert-butyltoluene, 1,3-di-tert-butylbenzene, 1,4-di-tert-butylbenzene, 1,3,5-tri-tert-butylbenzene, tert-pentylbenzene, 1-methyl-4-tert-pentylebenzene, 5-tert-pentyl-m-xylene, (1,1-diethylpropyl)benzene, 1,3-di-tert-pentylbenzene, 1,4-di-tert-pentylbenzene, or 4-tert-butylbiphenyl.

Note that, since Compound (d) functions as the above-described “Redox Shuttle,” it is necessary to dissolve it into an organic solvent or liquid dispersion medium. Consequently, it is preferable that an addition amount of the additive agent can be set to such an extent that it is dissoluble in a solvent. Although an addition amount of Compound (d) within the electrolytic solution depends on the types of Compound (d) and organic solvent, it is preferable to set the addition amount to fall in a range of from 0.01% by mass or more to less than 3.0% by mass, more preferably, from 0.1% by mass or more to 2.0% by mass or less. An addition amount of Compound (d) being less than 0.01% by mass makes it difficult to demonstrate the effects of Compound (d). Moreover, an addition amount of Compound (d) being 3.0% by mass or more is not preferable not only because the effects lower but also because the internal resistance of the resulting lithium-ion secondary battery rises.

### Compound (e)

Compound (e) is at least one member that is selected from the group consisting of N-alkyl pyrole and N-alkyl pyrole derivatives. As N-alkyl pyrole, the following are available: N-methylpyrole, N-ethyl pyrole, N-propyl pyrole, N-butyl pyrole, N-pentyl pyrole, N-hexyl pyrole, N-octyl pyrole, N-nonyl pyrole, N-dodecyl pyrole, or N-octadecyl pyrole. It is preferable, however, to use at least one member that is selected from the group consisting of N-methylpyrole, N-ethyl pyrole and N-propyl pyrole, because the more the number of carbon atoms in an alkyl group is the less likely N-alkyl pyrole becomes to dissolve in organic solvents.

Moreover, as for the N-alkyl pyrole derivatives, those in which an alkyl group, nitro group or amino group, and the like, is bonded onto one of the carbon atoms in the N-alkyl pyroles having been mentioned above. However, due to the same reason as above, it is possible to select and then use one of those in which an alkyl group, nitro group or amino group, and so on, is bonded onto one of the carbon atoms in N-methylpyrole, N-ethyl pyrole or N-propyl pyrole.

Note that it is necessary to dissolve Compound (e) into an organic solvent, and that it should be avoided as well to add it beyond the solubility. Although an addition amount of Compound (e) within the electrolytic solution depends on the types of Compound (e) and organic solvent, it is desirable to set the addition amount to fall in a range of from 0.05% by mass to less than 2.0% by mass. Compound (e) being less than 0.05% by mass makes it difficult to demonstrate the added effects, whereas becoming 2.0% by mass or more is not preferable not only because the effects lower but also because the internal resistance of the resulting lithium-ion secondary battery rises.

Note that the calculated values of “HOMO” and “LUMO” energies for some of Compounds (e) and organic solvents are given in Table 3. The calculating method was carried out based on “AM1.”

TABLE 3

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| N-Methylpyrole | −9.05 | 3.21 |
| N-Ethylpyrole | −8.99 | 3.09 |
| N-Propylpyrole | −8.99 | 3.07 |

Since Compounds (e) exhibit small “HOMO” absolute values, compared with those of the organic solvents, it is understood that they are likely to be oxidized on a positive electrode at the time of charging.

### Compound (f)

Compound (f) includes an oxygen-containing heterocyclic ring, and a carbonyl group being formed onto a carbon atom lying adjacent to one of oxygen atoms that constitute the oxygen-containing heterocyclic ring. For example, it is possible to choose it from at least one member that is selected from the group consisting of five-membered-ring γ-butyrolactone, γ-butyrolactone being provided with a substituent group, six-membered-ring δ-valerolactone, and δ-valerolactone being provided with a substituent group, and α-pyrone. It is not possible to employ four-or-less-membered lactones, because they are associated with anxieties in terms of the structural stability. Moreover, it is not possible to employ seven-or-more-membered lactones for fear of the steric hindrances.

As for a substituent group in the γ-butyrolactone being provided with a substituent group, an alkyl group, a nitro group, an amino group or a halogen group, and the like, is available. As for the γ-butyrolactone being provided with an alkyl group, the following can be exemplified: methyl-γ-butyrolactone (or γ-pentanolactone), or ethyl-γ-hexanolactone (or γ-caprolactone), for instance.

Moreover, as for a substituent group in the γ-valerolactone being provided with a substituent group, an alkyl group, a nitro group, an amino group or a halogen group, and the like, is available. As for the δ-valerolactone being provided with an alkyl group, the following can be exemplified: methyl-δ-valerolactone (or δ-hexanolactone), or ethyl-δ-valerolactone (or δ-heptanolactone), for instance.

Since the more the number of carbon atoms in an alkyl group is the less likely γ-butyrolactone and δ-valerolactone become to dissolve in organic solvents, it is preferable to use at least one member that is selected from the group consisting of γ-butyrolactone and δ-valerolactone that are not provided with any substituent group.

Note that it is necessary to dissolve Compound (f) into an organic solvent, and that it should be avoided as well to add it beyond the solubility. Although an addition amount of Compound (f) within the electrolytic solution depends on the types of Compound (f) and organic solvent, it is desirable to set the addition amount to fall in a range of 0.1% by mass or more, or 5% by mass or less. Compound (f) being less than 0.1% by mass makes it difficult to demonstrate the added effects, whereas becoming 5% by mass or more is not preferable not only because the effects lower but also because the internal resistance of the resulting lithium-ion secondary battery rises.

Note that the calculated values of “HOMO” and “LUMO” energies for Compounds (f) and organic solvents are given in Table 4. The calculating method was carried out based on “AM1.”

TABLE 4

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| γ-Butyrolactone | −11.24 | 1.10 |
| δ-Valerolactone | −10.82 | 1.15 |
| α-Pyrone | −10.75 | −0.26 |

Since Compounds (f) exhibit small “HOMO” absolute values, and since they also exhibit small “LUMO” absolute values, compared with those of the organic solvents, it is understood that, at the time of charging, they are likely to be oxidized on a positive electrode and are likely to be reduced on a negative electrode.

### Compound (g)

Compound (g) is at least one member that is selected from the group consisting of furan and furan derivatives. As for the furan derivatives, it is possible to use those compounds in which an alkyl group, nitro group, carboxyl group or amino group, and the like, substitutes for one of the hydrogen groups in the furan ring. It is possible to select one of the following to use: 2-methylfuran, 2,5-dimethylfuran, 2,4-dimethylfuran, 2-ethylfuran, 2,5-diethylfuran, 2,4-diethylfuran, 2-propylfuran, 2,5-dipropylfuran, 2,4-dipropylfuran, 2-nitorfuran, 2,5-dinitrofuran, 2,4-dinitrofuran, 2-nitrofuran-5-carbonitrile, 2-furancarboxylic acid, 3-furancarboxylic acid, 2,5-furandicarboxylic acid, 2-furancarbonyl, 3-furancarbonyl, di(2-furyl)hydroxy acetic acid, or fulfuryl methyl disulfide, for instance.

Note that it is necessary to dissolve Compound (g) into an organic solvent, and that it should be avoided as well to add it beyond the solubility. Although an addition amount of Compound (g) within the electrolytic solution depends on the types of Compound (g) and organic solvent, it is desirable to set the addition amount to fall in a range of from 0.05% by mass or more to less than 2.0% by mass. Compound (g) being less than 0.05% by mass makes it difficult to demonstrate the added effects, whereas becoming 2.0% by mass or more is not preferable not only because the effects lower but also because the internal resistance of the resulting lithium-ion secondary battery rises.

Note that the calculated values of “HOMO” and “LUMO” energies for some of Compounds (g) and organic solvents are given in Table 5. The calculating method was carried out based on “AM1.”

TABLE 5

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| Furan | −9.32 | 0.72 |
| 2-Nitrofuran | −8.06 | 1.09 |
| 3-Nitrofuran | −8.20 | 0.95 |

Since Compounds (g) exhibit small “HOMO” absolute values, and since they also exhibit small “LUMO” absolute values, compared with those of the organic solvents, it is understood that, at the time of charging, they are likely to be oxidized on a positive electrode and are likely to be reduced on a negative electrode.

### Compound (h)

Compound (h) is at least one member that is selected from the group consisting of polycyclic hydrocarbon compounds that are expressed by Chemical Formula 1, and their derivatives.

As shown in Chemical Formula 1, Compound (h) is at least one member that is selected from the group consisting of polycyclic hydrocarbons, which are made by single bonding one of carbon atoms in a cyclic hydrocarbon group being expressed by “R” directly onto one of carbon atoms being included in a benzene ring, and their derivative. The “R” is a cyclic hydrocarbon group whose number of carbon atoms is 5 or more, or can also be an alicyclic hydrocarbon group, or can even be an aromatic hydrocarbon group, or can further include both of them. Moreover, the “R” can also be monocyclic, or can even be polycyclic. As for such a cyclic hydrocarbon group, the following can be named: phenyl groups (or benzene rings), six-membered ringed ones, such as cyclohexyl groups, five-membered ringed ones, such as cyclopentyl groups, or condensed ringed ones, such as naphthyl groups. As for specific examples of an additive group possessing such a cyclic hydrocarbon group, the following can be named: biphenyl being specified in Chemical Formula 6 below, cyclohexylbenzene being specified in Chemical Formula 7 below, dicyclohexylbenzne being specified in Chemical Formula 8 below, diphenylcyclohexane being specified in Chemical Formula 9 below, or naphthylebenzene being specified in Chemical Formula 10 below. Note that Compound (h) can also be derivatives of these polycyclic hydrocarbon compounds. A collective term will be hereinafter given to the polycyclic hydrocarbon compounds of this sort, and to their derivatives, thereby calling them simply “polycyclic hydrocarbon compounds.”

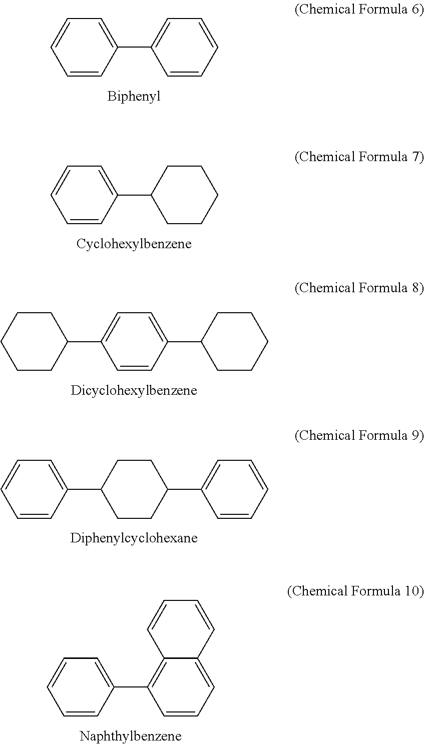

In accordance with the lithium-ion secondary battery according to the present invention, it is possible to inhibit decompositions of the electrolytic solution by adding Compound (h) to the electrolytic solution. Although its reason has not been apparent yet, it is believed that the polycyclic hydrocarbon compounds are oxidized at the positive electrode at the activation step and at the time of storage, so that they form polymerized coatings in which the cyclic hydrocarbon groups lie one after another as a shape of tortoiseshell on the positive electrode. And, it is believed that these polymerized coatings inhibit the electrolytic solution from decomposing at the positive electrode. And, it is believed that they inhibit troubles, which are caused by decompositions of the electrolytic solution, in the formation of insulating film, and so on, thereby inhibiting the post-storage charging and discharging capacities from lowering.

### Compound (i)

Compound (i) is at least one member that is selected from the group consisting of organosulfur compounds, which are made by bonding an alkoxy group onto at least one of carbon (C) atoms being included in a basic skeleton that comprises diphenyl disulfide, and derivatives of the organosulfur compounds.

As shown in Chemical Formula 11, diphenyl disulfide possesses two benzene rings. Sulfur (S) atoms are bonded onto one of carbon (C) atoms being included in each of the benzene rings, respectively. The two sulfur (S) atoms undergo the sulfide bond (i.e., S—S bond).

Compound (i) has diphenyl disulfide as the basic skeleton, and is at least one member of organosulfur compounds, which are made by bonding an alkoxy group onto at least one of carbon (C) atoms being included in this basic skeleton (more specifically, carbon (C) atoms being included in at least one of the benzene rings), and derivatives of these organosulfur compounds. For example, Compound (i) includes bis(alkoxyphenyl) disulfide that is made by bonding an alkoxy group one by one onto both benzene rings, which are included in a basic skeleton comprising diphenyl disulfide, respectively, as shown in Chemical Formula 12. The alkoxy group can be bonded onto any of the ortho-position (or second position), metha-position (or third position) and para-position (or fourth position). For reference, Chemical Formula 13 shows bis(4-methoxyphenyl)disulfide, in which a methoxy group, one kind of the alkoxy groups, is bonded onto the para-positions respectively, as one of the bis(alkoxyphenyl)disulfides.

The alkoxy group can be a common one, such as a methoxy group, ethoxy group, propoxy group or butoxy group, and is not at all limited to these especially. A collective term will be hereinafter given to the organosulfur compounds of this sort, thereby calling them simply “diphenyl-disulfide-based organosulfur compounds.”

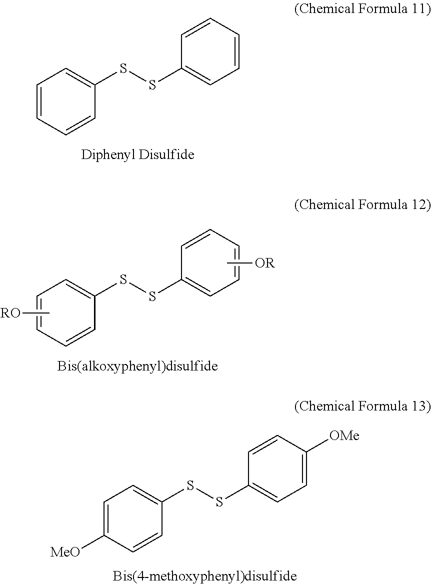

In accordance with the lithium-ion secondary battery according to the present invention, it is possible to inhibit decompositions of the electrolytic solution by adding Compound (i) to the electrolytic solution. Although its reason has not been apparent yet, it is believed that the diphenyl-disulfide-based organosulfur compounds are oxidized at the positive electrode and are reduced at the negative electrode at the activation step and at the time of storage, so that decomposed products form films onto the positive electrode, thereby inhibiting the electrolytic solution from decomposing at the positive electrode and negative electrode. And, it is believed that they inhibit troubles, which are caused by decompositions of the electrolytic solution, in the formation of insulating film, and so on, thereby inhibiting the post-storage charging and discharging capacities from lowering.

As for specific examples of the diphenyl-disulfide-based organosulfur compounds, the following can be given: bis(4-methoxyphenyl)disulfide, bis(3-methoxyphenyl)disulfide, bis(2-methoxyphenyl)disulfide, bis(4-ethoxyphenyl)disulfide, bis(3-ethoxyphenyl)disulfide, bis(2-ethoxyphenyl)disulfide, bis(4-propoxyphenyl)disulfide, bis(3-propoxyphenyl)disulfide, bis(2-propoxyphenyl)disulfide, bis(2,4-dimethoxyphenyl)disulfide, or bis(3,5-dimethoxyphenyl)disulfide.

Note that the calculated values regarding “HOMO” and “LUMO” energies for some of above-mentioned Compounds (i), and those of representative organic solvents are given in Table 6. The calculations were carried out based on the “AM1” method.

TABLE 6

| | HOMO (eV) | LUMO (eV) |
|---|---|---|
| Ethyl Carbonate | −11.90 | 1.24 |
| Methyl Ethyl Carbonate | −11.51 | 1.29 |
| Dimethyl Carbonate | −11.54 | 1.13 |
| Bis(4-methoxyphenyl)disulfide | −8.69 | −1.58 |
| (3-methoxyphenyl)(4-methoxyphenyl) | −6.30 | −1.28 |
| disulfide | | |
| (2-methoxyphenyl)(4-methoxyphenyl) | −6.26 | −1.36 |
| disulfide | | |
| Bis(3-methoxyphenyl)disulfide | −6.39 | −1.30 |

Since Compounds (i) exhibit small “HOMO”s, and since they also exhibit small “LUMO”s, compared with those of the organic solvents, it is understood that, at the time of charging, they are likely to be oxidized on a positive electrode and are likely to be reduced on a negative electrode. Consequently, it is believed that Compounds (i) are oxidized on a positive electrode and are reduced on a negative electrode, in preference to the organic solvents, so that they form films on the positive electrode, and on the negative electrode. It is believed that, by means of these films, the organic solvents become less likely to come in contact with the positive electrode and negative electrode, and thereby decompositions of the electrolytic solution are inhibited. And, it is believed that lithium-ion secondary batteries, which use the electrolytic solution that is less likely to be decomposed, exhibit lowering in the charging and discharging capacities less even after being stored. Note that bis(4-methoxyphenyl)disulfide, in which the methoxy group is bonded onto the para-position, is especially suitable for an additive agent, because it exhibits a large “HOMO” and small “LUMO.”

Other than including one of the compounds having been aforementioned, it is possible to construct the electrolytic solution according to the present invention in the same manner as conventional ones, so that it is possible to make it into one in which a metallic lithium salt, namely, an electrolyte, has been dissolved in an organic solvent. Although the organic solvent is not at all one which is limited especially, it is preferable that it can include a chain-shaped or linear ester from the perspective of load characteristic. As for such a chain-shaped ester, the following organic solvents can be given: chain-shaped carbonates, which are represented by dimethyl carbonate, diethyl carbonate and ethyl methyl carbonate; ethyl acetate; and methyl propionate, for instance. It is also allowable to use one of these chain-shaped esters independently, or to mix two or more kinds of them to use. In particular, in order for the improvement in low-temperature characteristic, it is preferable that one of the aforementioned chain-shaped esters can account for 50% by volume or more within the entire organic solvent; especially, it is preferable that the one of the chain-shaped esters can account for 65% by volume or more within the entire organic solvent.

However, as for an organic solvent, rather than constituting it of one of the aforementioned chain-shaped esters alone, it is preferable to mix an ester whose permittivity is high (e.g., whose permittivity is 30 or more) with one of the aforementioned chain-shaped esters to use in order to intend the upgrade in discharged capacity. As for a specific example of such an ester, the following can be given: cyclic carbonates, which are represented by ethylene carbonate, propylene carbonate, butylene carbonate and vinylene carbonate; γ-butyrolactone; or ethylene glycol sulfite, for instance. In particular, cyclically-structured esters, such as ethylene carbonate and propylene carbonate, are preferable. It is preferable that such an ester whose permittivity is high can be included in an amount of 10% by volume or more in the entire organic solvent, especially 20% by volume or more therein, from the perspective of discharged capacity. Moreover, from the perspective of load characteristic, 40% by volume or less is more preferable, and 30% by volume or less is much more preferable.

As for an electrolyte to be dissolved in the organic solvent, one of the following can be used independently, or two or more kinds of them can be mixed to use: LiClO₄, LiPF₆, LiBF₄, LiAsF₆, LiSbF₆, LiCF₃SO₃, LiC₄F₉SO₃, LiCF₃CO₂, Li₂C₂F₄(SO₃)₂, LiN(CF₃SO₂)₂, LiC(CF₃SO₂)₃, or LiCₙF₂ₙ₊₁SO₃ (where “n”≧2), for instance. Among them, LiPF₆ or LiC₄F₉SO₃, from which favorable charging and discharging characteristics are obtainable, can be used preferably.

Although a concentration of the electrolyte within the electrolytic solution is not at all one which is limited especially, it can preferably be from 0.3 to 1.7 mol/dm³, especially from 0.4 to 1.5 mol/dm³ approximately.

Moreover, in order to upgrade the safety or storage characteristic of battery, it is also allowable to make the electrolytic solution further contain an aromatic compound. As for an aromatic compound, benzenes having an alkyl group, such as cyclohexylbenzene and t-butylbenzene, biphenyl, or fluorobenzenes can be used preferably.

Note that, as for an electrolyte, it is possible to use gelatinous solid electrolytes as well in which liquid dispersion media are dispersed, although it is common to use a non-aqueous electrolyte that has been dissolved in an organic solvent. In this case, it is advisable to add one of the aforementioned additive agents to a dispersion medium.

The lithium-ion secondary battery according to the present invention is mainly equipped with a positive electrode, a negative electrode, and the non-aqueous electrolytic solution according to the present invention. Moreover, in the same manner as common lithium-ion secondary batteries, it is further equipped with a separator that is interposed between the positive electrode and the negative electrode.

The positive electrode is one which includes a positive-electrode active material comprising a lithium-manganese-based oxide that includes a lithium (Li) element and a tetravalent manganese (Mn) element and whose crystal structure belongs to a layered rock-salt structure. This positive-electrode active material has a lithium-manganese-based oxide, which is expressed by a compositional formula: xLi₂“M₁”O₃.(1−x)Li“M₂”O₂ (where 0≦“x”≦1; “M₁” is one or more kinds of metallic elements in which tetravalent Mn is essential; and “M₂” is two or more kinds of metallic elements in which tetravalent Mn is essential), as the basic composition. Note that it is needless to say that composite oxides, whose compositions have deviated slightly from the aforementioned compositional formula due to the deficiency in Li, “M₁,” “M₂” or O (i.e., oxygen) that occurs inevitably, are also included herein. Due to the presence of Mn with a valance number of less than tetravalence, a valance number of from 3.8 to 4 is permissible as for an average oxidation number of Mn in the entirety of an obtainable composite oxide. As for metallic elements other than tetravalent Mn in the “M₁” and “M₂.” it is possible to use at least one member that is selected from the group consisting of Cr, Fe, Co, Ni, Al, and Mg.

This positive-electrode active material can be produced by carrying out the following at least: a raw-material mixture preparation step of preparing a raw-material mixture by mixing a metallic-compound raw material, which includes one or more members of metallic elements in which Mn is essential, with a molten-salt raw material, which includes lithium hydroxide but does not include any other compounds substantially and which includes Li in an amount exceeding the theoretic composition of Li that is included in a targeted composite oxide; and a molten reaction step of melting the raw-material mixture to make it react at a melting point or more of the molten-salt raw material. By using a molten salt of lithium hydroxide, a lithium-manganese-based oxide, which includes Li and tetravalent Mn and which belongs to a layered rock-salt structure, is synthesized as a major product.

And, by means of setting the raw-material mixture at a high temperature that is the melting point or more of lithium hydroxide and then by making the raw-material mixture react within the molten salt, a fine-particle-shaped composite oxide is obtainable. This is because the raw-material mixture undergoes alkali fusion within the molten salt and is thereby mixed uniformly. Moreover, by making it react within the molten salt that comprises lithium hydroxide alone substantially, crystal growths are inhibited even when the reaction temperature is high temperatures, so that a composite oxide whose primary particles are on nano order is obtainable.

As for a raw material for supplying tetravalent Mn, the following are used: one or more kinds of metallic compounds, which are selected from the group consisting of oxides, hydroxides and metallic salts that include one or more metallic elements in which Mn is essential. One of these metallic compounds is essential for the metallic-compound raw material. To be concrete, the following can be given: manganese dioxide (MnO₂); dimanganese trioxide (Mn₂O₃); manganese monoxide (MnO); trimanganese tetraoxide (Mn₃O₄); manganese hydroxide (Mn(OH)₂); manganese oxyhydroxide (MnOOH); or metallic compounds in which a part of Mn in these oxides, hydroxides or metallic salts is substituted by Cr, Fe, Co, Ni, Al or Mg. It is allowable to use one kind or two or more kinds of these as an essential metallic compound, respectively. Among them, MnO₂ is preferable because not only it can be procured easily but also those with comparatively high purities are likely to be procured.

Here, Mn in the metallic compounds does not necessarily need to be tetravalent, but it is also allowable that it can be Mn with a valence number of 4 or less. This is due to the fact that even divalent or trivalent Mn turns into being tetravalent because reactions proceed under highly oxidizing conditions. This holds true similarly for the transition elements that substitute for Mn, too.

As for a compound including a metallic element that substitutes for a part of Mn, it is allowable to employ one or more kinds of second metallic compounds that are selected from the group consisting of oxides, hydroxide, and metallic salts. As for specific examples of the second metallic compounds, the following can be given: cobalt oxide (CoO, or Co₃O₄); cobalt nitrate (Co(NO₃)₂.6H₂O); cobalt hydroxide (Co(OH)₂); nickel oxide (NiO); nickel nitrate (Ni(NO₃)₂. 6H₂O); nickel sulfate (NiSO₄. 6H₂O); aluminum hydroxide (Al(OH)₃); aluminum nitrate (Al(NO₃)₃.9H₂O); copper oxide (CuO); copper nitrate (Cu(NO₃)₂.3H₂O); or calcium hydroxide (Ca(OH)₂). It is permissible to use one kind or two or more kinds of these as the second metallic compound, respectively.

The molten reaction step is a step in which the raw material-mixture is melted to cause it react. The reaction temperature is a temperature of the raw-material mixture at the molten reaction step, and it is advisable that it can be a melting point or more of the molten-salt raw material. However, at less than 500° C., the molten salt's reaction activity is insufficient so that it is difficult to produce desired composite oxides including tetravalent Mn with good selectivity. Moreover, when the reaction temperature is 550° C. or more, composite oxides, which are of high crystallinity, are obtainable. An upper limit of the reaction temperature can be less than the decomposition temperature of lithium hydroxide, and it is desirable that it can be 900° C. or less, or furthermore 850° C. or less. When employing manganese dioxide as a metallic compound that supplies Mn, it is desirable that the reaction temperature can be from 500 to 700° C., or furthermore from 550 to 650° C. The reaction temperature being too high is not desirable, because the decomposition reaction of the molten salt occurs. When the raw-material mixture is retained at this temperature for 30 minutes or more, more desirably for from 1 to 6 hours, it reacts sufficiently.

Moreover, when the molten reaction step is carried out in an oxygen-containing atmosphere, for example, in air or in a gaseous atmosphere including oxygen gas and/or ozone gas, composite oxides including tetravalent Mn are likely to be obtained in a single phase. When being an atmosphere containing oxygen gas, it is advisable to set an oxygen-gas concentration at from 20 to 100% by volume, or furthermore from 50 to 100% by volume. Note that the higher the oxygen concentration is set the smaller the particle diameters of composite oxides to be synthesized tend to become.

Structures of the composite oxides being obtainable by the aforementioned production process are a layered rock-salt structure, respectively. Being mainly made up of a layered rock-salt structure can be ascertained by means of X-ray diffraction (or XRD), electron-beam diffraction, and the like. Moreover, a layered structure is observable by high-resolution image using high-resolution transmission electron microscope (or TEM). When obtainable composite oxides are expressed by a compositional formula, they can be expressed by xLi₂“M₁”O₃.(1−x)Li“M₂”O₂ (where 0≦“x”≦1); wherein “M₁” is a metallic element in which tetravalent Mn is essential; and “M₂” is another metallic element in which tetravalent Mn is essential. Note that it is also allowable that Li can be substituted by hydrogen element (H) in an amount of 60% or less, or furthermore 45% or less, by atomic ratio. Moreover, although it is preferable that most of the “M₁” can be tetravalent Mn, it is even permissible that less than 50%, or furthermore less than 80%, can be substituted by the other metallic element.

As for metallic elements other than tetravalent Mn that constitute the “M₁” and “M₂,” it is preferable to select them from the group consisting of Ni, Al, Co, Fe, Mg and Ti, from the viewpoint of chargeable and dischargeable capacities in a case where they are made into an electrode material, respectively. Note that it is needless to say that composite oxides, whose compositions have deviated slightly from the aforementioned compositional formula due to the deficiency in Li, “M₁,” “M₂” or O (i.e., oxygen) that occurs inevitably, are also included herein. Therefore, a valance number of from 3.8 and up to 4 is permissible for an average oxidation number of “M₁,” and for an average oxidation number of Mn that is included in “M₂.”

To be concrete, the following can be given: Li₂MnO₃, LiNi_{1/3}Co_{1/3}Mn_{1/3}O₂, and LiNi_{0.5}Mn_{0.5}O₂; or solid solutions that include two or more kinds of these. It is also allowable that a part of the Mn, Ni or Co can be substituted by the other metallic elements. It is permissible that, as for the entirety of obtainable composite oxide, the composite oxides can be made up of the exemplified oxides as a basic composition, respectively. It is even advisable that their compositions can deviate slightly from the aforementioned compositional formula due to the deficiency in the metallic elements or oxygen that occurs inevitably.

A positive electrode of the lithium-ion secondary battery according to the present invention has a current collector, and an active-material layer being bound together onto the current collector. It is possible to make the active-material layer by means of the following steps: applying one, which has been made into a slurry by adding a conductive additive, a binder resin, and a proper amount of organic solvent, if needed, to a positive-electrode active material comprising the lithium-manganese-based oxide having been aforementioned whose crystal structure belongs to a layered rock-salt structure, and then mixing them with each other, onto the current collector by a method, such as roll coating methods, dip coating methods, doctor blade methods, spray coating methods and curtain coating methods; and curing the binder resin.

A negative electrode of the lithium-ion secondary battery according to the present invention can be formed by making metallic lithium, namely, a negative-electrode active material, into a sheet shape. Alternatively, it can be formed by press bonding the one, which has been made into a sheet shape, onto a current-collector net, such as nickel or stainless steel. Instead of metallic lithium, it is possible to use lithium alloys or lithium compounds as well. Moreover, in the same manner as the positive electrode, it is also allowable to employ a negative electrode comprising a negative-electrode active material, which can sorb and desorb lithium ions, and a binding agent. As for a negative-electrode active material, it is possible to use the following: graphite, such as natural graphite and artificial graphite; organic-compound calcined bodies, such as phenolic resins; and powders of carbonaceous substances, such as cokes, for instance. As for a binding agent, it is possible to use fluorine-containing resins, thermoplastic resins, and the like, in the same manner as the positive electrode.

Moreover, as a negative-electrode active material, it is also preferable to use a powder comprising a silicon oxide that is expressed by SiOₓ (where 0.3≦“x”≦1.6). It has been known that SiOₓ decomposes into Si and SiO₂ when being heat treated. This is said to be a “disproportionation reaction,” and thereby SiOₓ is separated into two phases, namely, an Si phase and an SiO₂ phase, by means of the internal reaction of solid. The Si phase being separated to be obtainable is fine extremely. Moreover, the SiO₂ phase covering the Si phase is provided with an action of inhibiting the decompositions of electrolytic solution. However, in a case where only a silicon oxide is used as the negative-electrode active material, since there might possibly arise such a case that the resulting cyclability becomes insufficient, it is desirable to combindely use a silicon oxide and a carbonaceous material, such as graphite, if such is the case.

Note that, in a case where artificial graphite is used as a negative-electrode active material, electrolytic solutions undergo reductive decompositions on the edge faces of the artificial graphite, as described above. As a result, there has been such a problem that the internal resistance of battery becomes higher, because “SEI” is formed onto the surfaces of the resultant negative electrode. On the contrary to this, SiOₓ does not possess any edge faces like those of the artificial graphite. Consequently, it is possible to inhibit non-aqueous electrolytic solutions from undergoing reductive decompositions by using SiOₓ as a negative-electrode active material. Note that, depending on cases, it is also allowable to add a carbonaceous material, such as artificial graphite, suitably to a negative-electrode active material. In this case, it is preferable that SiOₓ can be contained in an amount of 30% by mass or more when the entire negative-electrode active material is taken as 100% by mass. As for a current collector, conductive additive, binder resin and organic solvent, it is permissible to use the same ones as those of the positive-electrode active material.

Moreover, there are not any limitations especially on the current collector, conductive additive, binder agent, organic solvent, separator that are used for the positive electrode and negative electrode, either, so that they can be those which are employable in common lithium-ion secondary batteries.

As for a current collector, it is common to use meshes being made of metal, or metallic foils. For example, the following can be given: metallic materials, such as stainless steels, titanium, nickel, aluminum and copper; or porous or nonporous electrically conductive substrates comprising electrically conductive resins. As for a porous electrically conductive substrate, the following can be given: meshed bodies, netted bodies, punched sheets, lathed bodies, porous bodies, foamed bodies, and formed bodies of fibrous assemblies like nonwoven fabrics, for instance. As for a nonporous electrically conductive substrate, the following can be given: foils, sheets, and films, for instance. Moreover, it is also advisable to use current collectors comprising materials other than metals, such as carbon sheets.

A conductive additive is added in order to enhance the electric conductivity of electrode. As for a conductive additive, it is possible to add one of the following independently: carbonaceous fine particles, namely, carbon black, “MAG,” acetylene black (or AB), and KETJENBLACK (or KB); or gas-phase-method carbon fibers (or vapor grown carbon fibers (or VGCF)); or to combine two or more kinds of them to add. Although it is not at all restrictive especially as to an employment amount of the conductive additive, it is generally possible to set it to fall in a range of from 20 to 100 parts by mass with respect to 100 parts by mass of a positive-electrode active material. As for a binder resin, it is possible to use those which play a role of fastening the positive-electrode active material and the conductive additive together. For example, it is possible to use the following: fluorine-containing resins, such as polyvinylidene fluoride, polytetrafluoroethylene, and fluororubbers; and thermoplastic resins, such as polypropylene, and polyethylene.

As for an organic solvent for viscosity adjustment that is to be used in slurry, the following are employable: N-methyl-2-pyrrolidone (or NMP), methanol, or methyl isobutyl ketone (or MIBK).

As for a separator, it can be those which have sufficient strength, and besides which can retain electrolytic solutions as much as possible. From such a viewpoint, the following can be used preferably: those which have a thickness of from 5 to 50 μm: and which are made of micro-porous films being made from polypropylene, polyethylene or polyolefin, such as copolymers of propylene and ethylene; or nonwoven fabrics. In particular, in a case where such a thin separator as having from 5 to 20 μm in thickness is used, the characteristics of battery are likely to degrade during charging/discharging cycles or storage at high temperatures. However, since a lithium-ion secondary battery, in which the above-described composite oxide is used as the positive-electrode active material and which includes a chain-shaped or linear compound having a sultone group within the electrolytic solution, is excellent in terms of the stability and safety, it is possible to make the resulting battery function stably even when such a thin separator is used.

A configuration of lithium-ion secondary batteries, which are constituted by means of the constituent elements as above, can be made into various sorts of those such as cylindrical types, laminated types and coin types. Even in a case where any one of the configurations is adopted, the separators are interposed between the positive electrodes and the negative electrodes to make electrode assemblies. And, these electrode assemblies are sealed hermetically in a battery case after connecting intervals from the resulting positive-electrode current-collector assemblies and negative-electrode current-collector assemblies up to the positive-electrode terminals and negative-electrode terminals, which lead to the outside, with leads for collecting electricity, and the like, and then impregnating these electrode assemblies with the aforementioned electrolytic solution, and thereby a lithium-ion secondary battery completes.

In a case where lithium-ion secondary batteries are made use of, the positive-electrode active material is activated by carrying out charging in the first place. However, in a case where a positive-electrode active material comprising the composite oxide that belongs to a layered rock-salt structure is used, lithium ions are released at the time of first-round charging, and simultaneously therewith oxygen generates. Consequently, it is desirable to carry out charging before sealing the battery case hermetically.

The lithium-ion secondary battery according to the present invention having been explained as above can be utilized suitably in the field of automobile as well in addition to the field of communication device or information-related device such as cellular phones and personal computers. For example, when vehicles have this lithium-ion secondary battery on-board, it is possible to employ the lithium-ion secondary battery as an electric power source for electric automobile.

Hereinafter, the present invention will be explained in detail by means of examples.

### Example No. 1

<Making of Positive Electrode for Lithium-Ion Secondary Battery>

0.20-mol (i.e., 8.4-gram) lithium hydroxide monohydrate, LiOH.H₂O, which serves as a molten-salt raw material, was mixed with 0.02-mol (i.e., 1.74-gram) manganese dioxide, MnO₂, which serves as a metallic-compound raw material, to prepare a raw-material mixture. On this occasion, since the targeted product was Li₂MnO₃, a ratio, namely, (Li in Targeted Product)/(Li in Molten-salt Raw Material), was 0.04 mol/0.2 mol=0.2, assuming that all of Mn in the manganese dioxide was supplied to Li₂MnO₃.

After putting the raw-material mixture in a crucible and then transferring it inside a 700° C. electric furnace, it was heated at 700° C. for two hours in a vacuum. On this occasion, the raw-material mixture was fused to turn into a molten salt, and thereby a black-colored product deposited.

Next, the crucible, in which the molten salt was held, was taken out from the electric furnace after cooling it to room temperature within the electric furnace. After the molten salt was cooled fully to solidify, the solidified molten salt was dissolved in water by immersing the molten salt as being held in the crucible into 200-mL ion-exchanged water and then stirring them therein. Since the black-colored product was insoluble in water, the water turned into a black-colored suspension liquid. When filtering the black-colored suspension liquid, a transparent filtrate was obtained, and a black-colored, solid filtered substance was obtained on the filter paper. The obtained filtered substance was further filtered while washing it fully with use of acetone. After vacuum drying the post-washing black-colored solid at 120° C. for 12 hours, it was pulverized using a mortar and pestle.

An X-ray diffraction (or XRD) measurement, in which the CuKα ray was used, was carried out for the obtained black-colored powder. According to the XRD measurement, it was understood that the obtained compound had a layered rock-salt structure. Moreover, it was ascertained that the obtained black-colored powder's composition, which was obtained from an emission spectroscopic (e.g., ICP) analysis and an average valency analysis of Mn by means of oxidation-reduction titration, was Li₂MnO₃.

Note that the evaluation on the valency of Mn was carried out as follows. A sample was taken in an amount of 0.05 g in an Erlenmeyer flask; a 1% sodium oxalate solution was added thereto in an amount of 40 mL accurately; H₂SO₄ was further added thereto in an amount of 50 mL; and then the sample was dissolved within a 90° C. water bath in a nitrogen-gas atmosphere. To the resulting mixture solution, 0.1N potassium permanganate was dropped to titrate it, and the titration was carried out until an end point at which the mixture solution changed the color to a faint rouge-like color (i.e., a titer, “V₁”). Meanwhile, another 1% sodium oxalate solution was taken in an amount of 20 mL accurately in another flask, and another 0.1N potassium permanganate was dropped to titrate the sodium oxalate solution in the same manner as aforementioned until the end point (i.e., another titer, “V₂”). According to the following equation, an amount of oxalic acid, which was consumed when Mn with higher number of valence was reduced to Mn²⁺, was calculated as an oxygen amount (or active-oxygen amount) from the “V₁” and “V₂”.

(Active-oxygen Amount) (%)=[{(2×“V₂”−“V₁”)×0.00080}/(Amount of Sample)]×100

And, an averaged valency of Mn was calculated from an Mn amount in the sample (e.g., a measured value by ICP analysis) and the resulting active-oxygen amount.

The following were mixed one another in a proportion of 50:40:10 by mass ratio: the obtained composite oxide; acetylene black serving as a conductive additive; and polytetrafluoroethylene (or PTFE) serving as a binder resin. Subsequently, this mixture was press bonded onto an aluminum mesh, namely, a current collector. Thereafter, the mixture on the aluminum mesh was vacuum dried at 120° C. for 12 hours or more, and was then made into an electrode, namely, a positive electrode with 30×25 mm.

<Making of Negative Electrode for Lithium-Ion Secondary Battery>

First of all, an SiO powder (produced by SIGMA-ALDRICH Corp., and with 5-μm average particle diameter) was heat treated at 900° C. for 2 hours, thereby preparing an SiO powder with 5-μm average particle diameter. Due to this heat treatment, it was separated into two phases, an Si phase and an SiO₂ phase, by means of internal reaction of solid, when it was homogenous, solid silicon monoxide, SiO, in which a ratio between Si and O was 1:1 roughly. The Si phase, which was separated to be obtainable, was very fine extremely.

With 48 parts by mass of the obtained SiOₓ powder, the following were mixed: 34.4-part-by-mass graphite powder and 2.6-part-by-mass KETJENBLACK (or KB) powder serving as a conductive additive, respectively; and polyacrylic acid serving as a binder resin, thereby preparing a slurry. A compositional ratio between the respective components within the resulting slurry was the SiOₓ powder:the graphite powder:KETJENBLACK:the polyacrylic acid=48:34.4:2.6:15 when being taken respectively as the solid content. This slurry was coated onto a surface of a 20-μm-thickness electrolytic copper foil, namely, a current collector, using a doctor blade, thereby forming a negative-electrode active-material layer on the copper foil.

Thereafter, the negative-electrode active-material layer was dried at 80° C. for 20 minutes, thereby evaporating the organic solvent to remove it from the negative-electrode active-material layer. After the drying, the current collector and the negative-electrode active-material layer were adhered closely and are then joined firmly by means of a roll pressing machine. This one was heat cured at 200° C. for 2 hours, thereby making it into an electrode whose active-material layer's thickness was 15 μm approximately, namely, a negative electrode with 31×26 mm.

Note that it is also allowable to use a negative electrode being doped with lithium as the negative electrode.

<Making of Lithium-Ion Secondary Battery>

An electrolytic solution was prepared by not only dissolving LiPF₆ in a concentration of 1 M into a mixed solvent in which ethylene carbonate, ethyl methyl carbonate and dimethyl carbonate were mixed in a volumetric ratio of 1:1:1, but also adding 2,3-butanediol-dimethanesulfonate to it so as to make 0.5% by weight and then dissolving it into the mixed solvent.

And, a 20-μm-thickness microporous polyethylene film was interposed between the positive electrode and the negative electrode, thereby turning them into an electrode assembly. This electrode assembly was wrapped up with a laminated film, and was then heat fused at the circumference in order to make an externally-film-packed battery. Before sealing a final one of the sides by heat fusing, the above-mentioned electrolytic solution was injected, thereby impregnating the electrode assembly with the electrolytic solution. Thereafter, CCCV charging (i.e., constant-current constant-voltage charging) was carried out up to 4.5 V at 0.2 C in order to activate the positive-electrode active material.

<Test>

(Calculation of Conserved Capacity)

A high-temperature storage test, in which the above-mentioned lithium-ion secondary battery was stored at 80° C. for 5 days, was carried out, during which the 1C discharged capacities before and after the high-temperature storage test were measured respectively in order to calculate a conserved capacity from the following equation.

Conserved Capacity=100×{(1C Discharged Capacity Immediately after Storage)/(1C Discharged Capacity before Storage)}

(Calculation of Recovered Capacity)

A high-temperature storage test, in which the above-mentioned lithium-ion secondary battery was stored at 80° C. for 5 days, was carried out, during which the 1C discharged capacity before the high-temperature storage test, and the 1C discharged capacity after 100% SOC charging that followed discharging after the high-temperature storage, were measured respectively in order to calculate a recovered capacity from the following equation.

Recovered Capacity=100×{(1C Discharged Capacity after 100% SOC Charging that followed Discharging after High-temperature Storage)/(1C Discharged Capacity before Storage)}

(Calculation of Rate of Rise in Internal Resistance)

A high-temperature storage test, in which the above-mentioned lithium-ion secondary battery was stored at 80° C. for 5 days, was carried out, during which the battery's internal resistances before and after the high-temperature storage test were measured respectively in order to calculate a rate of rise in the internal resistance from the following equation.

Rate of Rise in Internal Resistance=100×[{(Resistance Value after Storage)−(Resistance Value before Storage)}/(Resistance Value before Storage)]

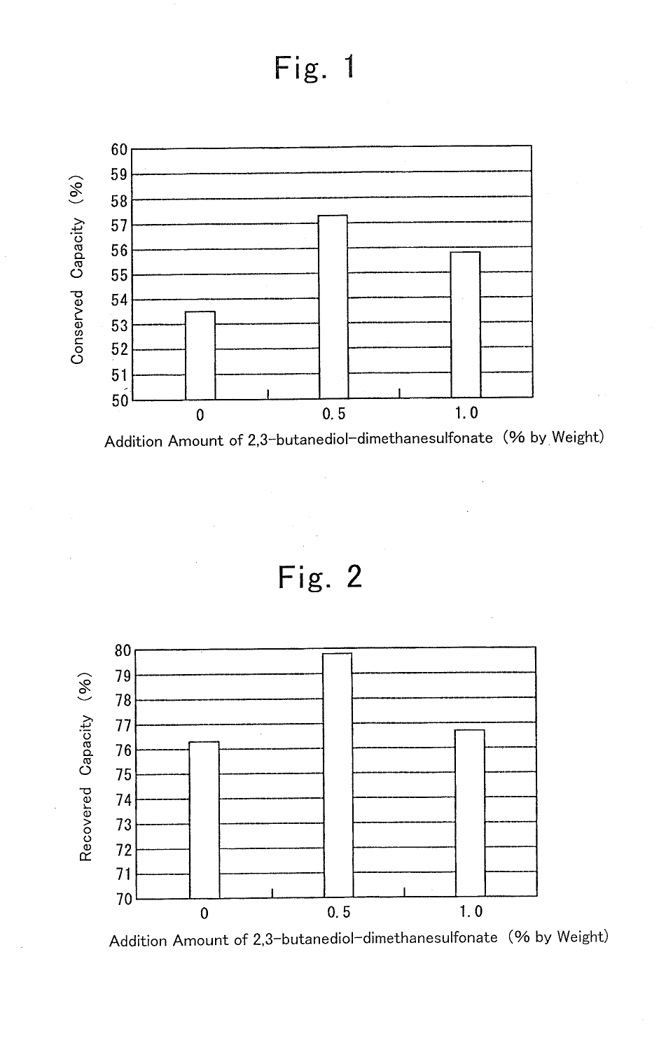

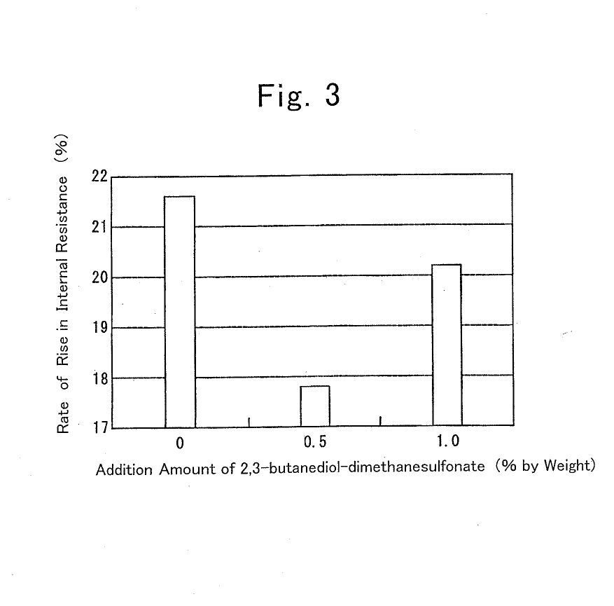

The respective results are illustrated in FIG. 1 through FIG. 3.

### Example No. 2

Except that the addition amount of 2,3-butanediol-dimethanesulfonate to the electrolytic solution was set at 1.0% by mass, a lithium-ion secondary battery was made in the same manner as Example No. 1. Except that this lithium-ion secondary battery was used, the conserved capacity, recovered capacity and rate of rise in the internal resistance were calculated in the same manner as Example No. 1. The respective results are illustrated in FIG. 1 through FIG. 3.

### Comparative Example No. 1

Except that 2,3-butanediol-dimethane sulfonate was not added to the electrolytic solution, a lithium-ion secondary battery was made in the same manner as Example No. 1. Except that this lithium-ion secondary battery was used, the conserved capacity, recovered capacity and rate of rise in the internal resistance were calculated in the same manner as Example No. 1. The respective results are illustrated in FIG. 1 through FIG. 3.

<Evaluation>

It is apparent from FIG. 1 through FIG. 3 that the lithium-ion secondary batteries according to the examples exhibited not only a conserved capacity and recovered capacity that had augmented, but also a rate of rise in internal resistance that had decreased, respectively, compared with those of the lithium-ion secondary battery according to Comparative Example No. 1. It is apparent that these are effects that stem from including 2,3-butanediol-dimethanesulfonate within the electrolytic solution.

Moreover, it is suggested from FIG. 1 through FIG. 3 that an optimum range is present in the content of 2,3-butanediol-dimethanesulfonate, and it is believed that approximately 0.5% by weight within the electrolytic solution can be optimum.

### Example No. 3

An electrolytic solution was prepared by not only dissolving LiPF₆ in a concentration of 1 M into a mixed solvent in which ethylene carbonate and ethyl methyl carbonate were mixed in a volumetric ratio of 1:1, but also adding 2-pyrone-4,6-dicarboxylic acid to it so as to make 0.1% by weight and then dissolving it into the mixed solvent.

Except that this electrolytic solution was used, a lithium-ion secondary battery was made in the same manner as Example No. 1, and the positive-electrode active material was activated in the same manner as Example No. 1.

(Calculation of Recovery Percentage of Capacity)

A high-temperature storage test, in which the above-mentioned lithium-ion secondary battery was stored at 80° C. for 5 days, was carried out, during which the 1C discharged capacity before the high-temperature storage test, and the 1C discharged capacity after 100% SOC charging that followed discharging after the high-temperature storage, were measured respectively in order to calculate a recovery percentage of the capacity from the following equation.

Recovery Percentage of Capacity=100×{(1C Discharged Capacity after 100% SOC Charging that followed Discharging after High-temperature Storage)/(1C Discharged Capacity before Storage)}

The result is shown in Table 7.

(Calculation of Rate of Rise in Internal Resistance)

A high-temperature storage test, in which the above-mentioned lithium-ion secondary battery was stored at 80° C. for 5 days, was carried out, during which the battery's internal resistances before and after the high-temperature storage test were measured respectively in order to calculate a rate of rise in the internal resistance from the following equation.

Rate of Rise in Internal Resistance=100×[{(Resistance Value after Storage)−(Resistance Value before Storage)}/(Resistance Value before Storage)]

The result is shown in Table 7.

### Comparative Example No. 2

Except that furan was not added to the electrolytic solution, a lithium-ion secondary battery was made in the same manner as Example No. 3. Except that this lithium-ion secondary battery was used, the recovery percentage of the capacity and rate of rise in the internal resistance were calculated in the same manner as Example No. 3. The respective results are shown in Table 7.

<Evaluation>

TABLE 7

| | Recovery | Rate of Rise in |
|---|---|---|
| | Percentage of | Internal |
| | Capacity (%) | Resistance (%) |
| Ex. No. 3 | 83.0 | 13.0 |
| Comp. Ex. No. 2 | 76.3 | 21.6 |

It is apparent from Table 7 that the lithium-ion secondary battery according to Example No. 3 exhibited not only a recovered capacity that had augmented, but also a rate of rise in the internal resistance that had decreased, compared with those of the lithium-ion secondary battery according to Comparative Example No. 2. It is apparent that these are effects that stem from including 2-pyrone-4,6-dicarboxylic acid within the electrolytic solution.

### Example No. 4

<Making of Negative Electrode>

With 48 parts by mass of an SiOₓ powder being obtained in the same manner as Example No. 1, the following were mixed: 34.4-part-by-mass graphite powder and 2.6-part-by-mass KETJENBLACK (or KB) powder serving as a conductive additive, respectively; and polyacrylic acid serving as a binder resin, thereby preparing a slurry. A compositional ratio between the respective components within the resulting slurry was the SiOₓ powder:the graphite powder:KETJENBLACK:the polyacrylic acid=48:34.4:2.6:15 when being taken respectively as the solid content. Using this slurry, a negative-electrode active-material layer was formed onto a surface of a copper foil in the same manner as Example No. 1, thereby forming a negative electrode whose thickness of the active-material layer was 15 μm approximately.

<Making of Lithium-Ion Secondary Battery>

A non-aqueous electrolytic solution was prepared by not only dissolving LiPF₆ in a concentration of 1 M into a mixed solvent in which ethylene carbonate and ethyl methyl carbonate were mixed in a volumetric ratio of 3:7, but also adding thiophene to it so as to make 0.1% by weight and then dissolving it into the mixed solvent.

And, a 20-μm-thickness microporous polyethylene film was interposed between the same positive electrode as that of Example No. 1 and the negative electrode having been aforementioned, thereby turning them into an electrode assembly. This electrode assembly was wrapped up with a laminated film, and was then heat fused at the circumference in order to make an externally-film-packed battery. Before sealing a final one of the sides by heat fusing, the above-mentioned electrolytic solution was injected, thereby impregnating the electrode assembly with the electrolytic solution. Thereafter, CCCV charging (i.e., constant-current constant-voltage charging) was carried out up to 4.5 V at 0.2 C in order to activate the positive-electrode active material.

<Test>

(Calculation of Recovery Percentage of Capacity)

A high-temperature storage test, in which the above-mentioned lithium-ion secondary battery was stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity. The result is shown in Table 8.

### Comparative Example No. 3

Except that thiophene was not added to the non-aqueous electrolytic solution, a lithium-ion secondary battery was made in the same manner as Example No. 4. Except that this lithium-ion secondary battery was used, a recovery percentage of the capacity was calculated in the same manner as Example No. 4. The result is shown in Table 8. The respective results are illustrated in FIG. 1 through FIG. 3.

<Evaluation>

TABLE 8

| | Recovery Percentage of |
|---|---|
| | Capacity (%) |
| Ex. No. 4 | 75.4 |
| Comp. Ex. No. 3 | 73.9 |

It is apparent from Table 8 that the lithium-ion secondary battery according to Example No. 4 exhibited a recovery percentage of the capacity that had augmented, compared with that of the lithium-ion secondary battery according to Comparative Example No. 3. It is apparent that this is an effect that stems from including thiophene within the non-aqueous electrolytic solution.

### Example No. 5

<Making of Positive Electrode>

The following were mixed one another in a proportion of 88:6:6 by mass ratio:a positive-electrode active material being obtained in the same manner as Example No. 1; acetylene black serving as a conductive additive; and polyvinylidene fluoride (or PVdF) serving as a binder resin. Subsequently, this slurry was coated onto a 20-μm-thickness aluminum foil, namely, a current collector, using a doctor blade, thereby forming a positive-electrode active-material layer on the aluminum foil. Thereafter, the slurry on the aluminum foil was vacuum dried at 120° C. for 12 hours or more, and was then made into an electrode, namely, a positive electrode with 30×25 mm.

<Making of Negative Electrode>

With 42 parts by mass of an SiOₓ powder being obtained in the same manner as Example No. 1, the following were mixed: 40-part-by-mass “MAG” powder and 3-part-by-mass KETJENBLACK (or KB) powder serving as a conductive additive, respectively; and polyamide-imide serving as a binder resin, thereby preparing a slurry. A compositional ratio between the respective components within the resulting slurry was the SiOₓ powder: the “MAG” powder: KETJENBLACK: the polyamide-imide=42:40:3:15 when being taken respectively as the solid contents. This slurry was coated onto a surface of a 20-μm-thickness electrolytic copper foil, namely, a current collector, using a doctor blade, thereby forming a negative-electrode active-material layer on the copper foil.

<Making of Lithium-Ion Secondary Battery>

LiPF₆ was dissolved into a mixed solvent, in which ethylene carbonate and ethyl methyl carbonate were mixed in a volumetric ratio of 3:7, so as to make a concentration of 1 M. An electrolytic solution was prepared by adding tert-butylbenzene to this mixed liquid so as make 1% by mass and then dissolving tert-butylbenzene into it.

And, a 20-μm-thickness microporous polyethylene film was interposed between the positive electrode and negative electrode that have been mentioned above, thereby turning them into an electrode assembly. This electrode assembly was wrapped up with a laminated film, and was then heat fused at the circumference in order to make an externally-film-packed battery. Before sealing a final one of the sides by heat fusing, the above-mentioned electrolytic solution was injected, thereby impregnating the electrode assembly with the electrolytic solution. Thereafter, CCCV charging (i.e., constant-current constant-voltage charging) was carried out up to 4.5 V at 0.2 C in order to activate the positive-electrode active material.

### Example No. 6

A lithium-ion secondary battery according to Example No. 6 is one which is identical with the lithium-ion secondary battery according to Example No. 5 other than the addition amount of the additive agent. To be concrete, in Example No. 6, the addition amount of tert-butylbenzene was 2% by mass when the entire electrolytic solution was taken as 100% by mass.

### Example No. 7

A lithium-ion secondary battery according to Example No. 7 is one which is identical with the lithium-ion secondary battery according to Example No. 5 other than the type of its additive agent. To be concrete, tert-pentylbenzene was used as the additive agent in Example No. 7. Note that, in Example No. 7, the addition amount of tert-pentylbenzene was 1% by mass when the entire electrolytic solution was taken as 100% by mass.

### Example No. 8

A lithium-ion secondary battery according to Example No. 8 is one which is identical with the lithium-ion secondary battery according to Example No. 7 other than the addition amount of the additive agent. To be concrete, tert-pentylbenzene was used as the additive agent in Example No. 8; and the addition amount of tert-pentylbenzene was 2% by mass when the entire electrolytic solution was taken as 100% by mass.

### Example No. 9

A lithium-ion secondary battery according to Example No. 9 is one which is identical with the lithium-ion secondary battery according to Example No. 7 other than the addition amount of the additive agent. To be concrete, tert-pentylbenzene was used as the additive agent in Example No. 9; and the addition amount of tert-pentylbenzene was 3% by mass when the entire electrolytic solution was taken as 100% by mass.

### Comparative Example No. 4

Except that no additive agent was added, a lithium-ion secondary battery according to Comparative Example No. 4 is one which is otherwise identical with the lithium-ion secondary battery according to Example No. 5.

<Test>

A high-temperature storage test, in which the above-mentioned lithium-ion secondary batteries were stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity and a rate of rise in the internal resistance, respectively. The results are shown in Table 9.

TABLE 9

| | Additive Agent | | | |
|---|---|---|---|---|
| | (%) | | Recovery | |
| | Tert- | Tert- | Percentage | Rate of Rise in |
| | butyl- | pentyl- | of capacity | Internal |
| | benzene | benzene | (%) | Resistance (%) |
| Ex. No. 5 | 1 | — | 76.0 | 37.5 |
| Ex. No. 6 | 1 | — | 78.1 | 29.1 |
| Ex. No. 7 | — | 1 | 79.6 | 33.3 |
| Ex. No. 8 | — | 2 | 79.3 | 26.1 |
| Ex. No. 9 | — | 3 | 77.3 | 46.7 |
| Comp. Ex. No. 4 | — | — | 73.9 | 44.2 |

<Evaluation>

As shown in Table 9, the lithium-ion secondary batteries according to Example Nos. 5 through 9 exhibited a recovery percentage of the capacity that had augmented, compared with that of the lithium-ion secondary battery according to Comparative Example No. 4. To be concrete, the lithium-ion secondary battery according to Example No. 5, which included 1%-by-mass tert-butylbenzene in the electrolytic solution, exhibited a recovery percentage of the capacity that had augmented by 2.1%, and a rate of rise in the internal resistance that had decreased by 6.7%, compared with those of the lithium-ion secondary battery according to Comparative Example No. 4, which did not include any additive agent in the electrolytic solution. Likewise, the lithium-ion secondary battery according to Example No. 6, which included 2%-by-mass tert-butylbenzene in the electrolytic solution, exhibited a recovery percentage of the capacity that had augmented by 4.2%, and a rate of rise in the internal resistance that had decreased by 15.1%. The lithium-ion secondary battery according to Example No. 7, which included 1%-by-mass tert-pentylbenzene in the electrolytic solution, exhibited a recovery percentage of the capacity that had augmented by 5.7%, and a rate of rise in the internal resistance that had decreased by 10.9%. The lithium-ion secondary battery according to Example No. 8, which included 2%-by-mass tert-pentylbenzene in the electrolytic solution, exhibited a recovery percentage of the capacity that had augmented by 5.4%, and a rate of rise in the internal resistance that had decreased by 18.1%. The lithium-ion secondary battery according to Example No. 9, which included 3%-by-mass tert-pentylbenzene in the electrolytic solution, exhibited a recovery percentage of the capacity that had augmented by 3.4%. Note that adding tert-butylbenzene to the electrolytic solution in an amount of this or more is not preferable because it leads to making a rate of rise in the internal resistance greater.

From these results, it is possible to augment lithium-ion secondary batteries in terms of a recovery percentage of the capacity by adding tert-alkylbenzene to the electrolytic solutions. In other words, the lithium-ion secondary battery according to the present invention that includes tert-alkylbenzene in the electrolytic solution exhibits charging and discharging capacities that are less likely to lower even after it is stored.

Moreover, as described above, in a case where the addition amount of tert-alkylbenzene is sufficiently less (in a case where it is less than 3.0% by mass, for instance), it is possible to inhibit the internal resistance of the resulting lithium-ion secondary batteries from rising.

### Example No. 10

<Making of Lithium-Ion Secondary Battery>

An electrolytic solution was prepared by not only dissolving LiPF₆ in a concentration of 1 M into a mixed solvent in which ethylene carbonate and ethyl methyl carbonate were mixed in a volumetric ratio of 3:7, but also adding 2-pyrone-4,6-dicarboxylic acid to it so as to make 0.1% by weight and then dissolving it into the mixed solvent.

Except that this electrolytic solution was used, a lithium-ion secondary battery was made in the same manner as Example No. 1, and the positive-electrode active material was activated in the same manner as Example No. 1.

<Test>

(Calculation of Recovery Percentage of Capacity)

A high-temperature storage test, in which the above-mentioned lithium-ion secondary was stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity. The result is shown in Table 10.

### Comparative Example No. 5

Except that N-methylpyrole was not added to the electrolytic solution, a lithium-ion secondary battery was made in the same manner as Example No. 10. Except that this lithium-ion secondary battery was used, a recovery percentage of the capacity was calculated in the same manner as Example No. 10. The result is shown in Table 10.

<Evaluation>

TABLE 10

| | Recovery Percentage of |
|---|---|
| | Capacity (%) |
| Ex. No. 10 | 77.3 |
| Comp. Ex. No. 5 | 73.9 |

It is apparent from Table 10 that the lithium-ion secondary battery according to Example No. 10 exhibited a recovery percentage of the capacity that had augmented, compared with that of the lithium-ion secondary battery according to Comparative Example No. 5. It is apparent that this is an effect that stems from including N-methylpyrole in the electrolytic solution.

### Example No. 11

<Making of Positive Electrode>

The following were mixed one another in a proportion of 88:6:6 by mass ratio:a positive-electrode active material being obtained in the same manner as Example No. 1; acetylene black serving as a conductive additive; and polyvinylidene fluoride (or PVdF) serving as a binder resin. Subsequently, this slurry was coated onto a 20-μm-thickness aluminum foil, namely, a current collector, using a doctor blade, thereby forming a positive-electrode active-material layer on the aluminum foil. Thereafter, the slurry on the aluminum foil was vacuum dried at 120° C. for 12 hours or more, and was then made into an electrode, namely, a positive electrode with 30×25 mm.

<Making of Negative Electrode>

With 42 parts by mass of an SiOₓ powder being obtained in the same manner as Example No. 1, the following were mixed: 40-part-by-mass “MAG” powder and 3-part-by-mass KETJENBLACK (or KB) powder serving as a conductive additive, respectively; and polyamide-imide serving as a binder resin, thereby preparing a slurry. A compositional ratio between the respective components within the resulting slurry was the SiOₓ powder: the “MAG” powder: KETJENBLACK: the polyamide-imide=42:40:3:15 when being taken respectively as the solid content. This slurry was coated onto a surface of a 20-μm-thickness electrolytic copper foil, namely, a current collector, using a doctor blade, thereby forming a negative-electrode active-material layer on the copper foil.

<Making of Lithium-Ion Secondary Battery>

A non-aqueous electrolytic solution was prepared by not only dissolving LiPF₆ in a concentration of 1 M into a mixed solvent in which ethylene carbonate and diethyl carbonate were mixed in a volumetric ratio of 3:7, but also adding γ-butyrolactone to it so as to make 1% by weight and then dissolving it into the mixed solvent.

Except that this electrolytic solution was used, a lithium-ion secondary battery was made in the same manner as Example No. 1, and the positive-electrode active material was activated in the same manner as Example No. 1.

<Test>

(Calculation of Recovery Percentage of Capacity)

A high-temperature storage test, in which the above-mentioned lithium-ion secondary battery was stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity. The result is shown in Table 11.

(Calculation of Rate of Rise in Internal Capacity)

A high-temperature storage test, in which the above-mentioned lithium-ion secondary battery was stored at 80° C. for 5 days, was carried out, during which the battery's internal resistances before and after the high-temperature storage test were measured respectively in order to calculate a rate of rise in the internal resistance. The result is shown in Table 11.

### Comparative Example No. 6

Except that γ-butyrolactone was not added to the non-aqueous electrolytic solution, a lithium-ion secondary battery was made in the same manner as Example No. 11. Except that this lithium-ion secondary battery was used, a recovery percentage of the capacity, and a rate of rise in the internal resistance were calculated in the same manner as Example No. 11. The respective results are shown in Table 11.

<Evaluation>

TABLE 11

| | Recovery | Rate of Rise in |
|---|---|---|
| | Percentage of | Internal |
| | Capacity (%) | Resistance (%) |
| Ex. No. 11 | 82.0 | 24.8 |
| Comp. Ex. No. 6 | 76.9 | 30.9 |

It is apparent from Table 11 that the lithium-ion secondary battery according to Example No. 11 exhibited not only an upgraded recovery percentage of the capacity, but also a decreased rate of rise in the internal resistance, compared with those of the lithium-ion secondary battery according to Comparative Example No. 6. It is apparent that these are effects that stem from including γ-butyrolactone within the electrolytic solution.

### Example No. 12

<Making of Lithium-Ion Secondary Battery>

A non-aqueous electrolytic solution was prepared by not only dissolving LiPF₆ in a concentration of 1 M into a mixed solvent in which ethylene carbonate and ethyl methyl carbonate were mixed in a volumetric ratio of 3:7, but also adding furan to it so as to make 0.1% by weight and then dissolving it into the mixed solvent.

Except that this electrolytic solution was used, a lithium-ion secondary battery was made in the same manner as Example No. 1, and the positive-electrode active material was activated in the same manner as Example No. 1.

<Test>

(Calculation of Recovery Percentage of Capacity)

A high-temperature storage test, in which the above-mentioned lithium-ion secondary was stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity. The result is shown in Table 12.

### Comparative Example No. 7

Except that furan was not added to the electrolytic solution, a lithium-ion secondary battery was made in the same manner as Example No. 12. Except that this lithium-ion secondary battery was used, a recovery percentage of the capacity was calculated in the same manner as Example No. 12. The result is shown in Table 12.

<Evaluation>

TABLE 12

| | Recovery Percentage of |
|---|---|
| | Capacity (%) |
| Ex. No. 12 | 74.9 |
| Comp. Ex. No. 7 | 73.9 |

It is apparent Table 12 that the lithium-ion secondary battery according to Example No. 12 exhibited an augmented percentage recovery capacity of the capacity, compared with that of the lithium-ion secondary battery according to Comparative Example No. 7. It is apparent that this is an effect that stems from including furan within the electrolytic solution.

### Example No. 13

<Making of Positive Electrode>

The following were mixed one another in a proportion of 88:6:6 by mass ratio: a positive-electrode active material being obtained in the same manner as Example No. 1; acetylene black serving as a conductive additive; and polyvinylidene fluoride (or PVdF) serving as a binder resin. Subsequently, this slurry was coated onto a 20-μm-thickness aluminum foil, namely, a current collector, using a doctor blade, thereby forming a positive-electrode active-material layer on the aluminum foil. Thereafter, the slurry on the aluminum foil was vacuum dried at 120° C. for 12 hours or more, and was then made into an electrode, namely, a positive electrode with 30×25 mm.

<Making of Negative Electrode>

With 42 parts by mass of an SiOₓ powder being obtained in the same manner as Example No. 1, the following were mixed: 40-part-by-mass “MAG” powder and 3-part-by-mass KETJENBLACK (or KB) powder serving as a conductive additive, respectively; and polyamide-imide serving as a binder resin, thereby preparing a slurry. A compositional ratio between the respective components within the resulting slurry was the SiOₓ powder: the “MAG” powder: KETJENBLACK: the polyamide-imide=42:40:3:15 when being taken respectively as the solid content. This slurry was coated onto a surface of a 20-μm-thickness electrolytic copper foil, namely, a current collector) using a doctor blade, thereby forming a negative-electrode active-material layer on the copper foil.

<Making of Lithium-Ion Secondary Battery>

LiPF₆ was dissolved into a mixed solvent, in which ethylene carbonate and ethyl methyl carbonate were mixed in a volumetric ratio of 3:7, so as to make a concentration of 1 M. A non-aqueous electrolytic solution was prepared by adding biphenyl to this mixed liquid so as to make 0.05% by mass and then dissolving biphenyl into it.

A 20-μm-thickness microporous polyethylene film serving as a separator was interposed between the positive electrode and negative electrode that have been mentioned above, thereby turning them into an electrode assembly. This electrode assembly was wrapped up with a laminated film, and was then heat fused at the circumference in order to make an externally-film-packed battery. Before sealing a final one of the sides by heat fusing, the above-mentioned electrolytic solution was injected, thereby impregnating the electrode assembly with the electrolytic solution. Thereafter, CCCV charging (i.e., constant-current constant-voltage charging) was carried out up to 4.5 V at 0.2 C in order to activate the positive-electrode active material.

### Example No. 14

Except that cyclohexylbenzene was added as an additive agent, and that a content of the cyclohexylbenzene was 0.5% by mass when the entire electrolytic solution was taken as 100% by mass, a lithium-ion secondary battery according to Example No. 14 was otherwise identical with Example No. 13.

Except that no additive agent was added, a lithium-ion secondary battery according to Comparative Example No. 8 was one which was otherwise identical with Example No. 13.

<Test>

(Calculation of Recovery Percentage of Capacity)

A high-temperature storage test, in which the above-mentioned lithium-ion secondary batteries were stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity, respectively. The results are shown in Table 13.

(Calculation of Rate of Rise in Internal Resistance)

A high-temperature storage test, in which the above-mentioned lithium-ion secondary batteries were stored at 80° C. for 5 days, was carried out, during which the batteries' internal resistances before and after the high-temperature storage test were measured respectively in order to calculate a rate of rise in the internal resistance, respectively. The results are shown in Table 13.

<Evaluation>

TABLE 13

| | Recovery | Rate of Rise in |
|---|---|---|
| | Percentage of | Internal |
| | Capacity (%) | Resistance (%) |
| Ex. No. 13 | 75.1 | 34.8 |
| Ex. No. 14 | 76.0 | 19.3 |
| Comp. Ex. No. 8 | 73.9 | 44.2 |

As shown in Table 13, the lithium-ion secondary batteries according to Example Nos. 13 and 14 respectively exhibited a recovery percentage of the capacity that had augmented, compared with that of the lithium-ion secondary battery according to Comparative Example No. 8. To be concrete, the lithium-ion secondary battery according to Example No. 13, which included 0.05%-by-mass biphenyl in the electrolytic solution, exhibited a recovery percentage of the capacity that augmented by 1.2%, and a rate of rise in the internal resistance that decreased by 9.4%, compared with those of the lithium-ion secondary battery according to Comparative Example No. 8, which did not include any additive agent in the electrolytic solution. Moreover, the lithium-ion secondary battery according to Example No. 14, which included 0.5%-by-mass cyclohexylbenzene in the electrolytic solution, exhibited a recovery percentage of the capacity that augmented by 2.1%, and a rate of rise in the internal resistance that decreased by 24.9%, compared with those of the lithium-ion secondary battery according to Comparative Example No. 8, which did not include any additive agent in the electrolytic solution.

From these results, it is possible to augment lithium-ion secondary batteries in terms of a recovery percentage of the capacity by adding one of the additive agents, namely, a polycyclic hydrocarbon compound, to the electrolytic solutions. In other words, the lithium-ion secondary battery according to the present invention that includes a polycyclic hydrocarbon compound in the electrolytic solution exhibits charging and discharging capacities that are less likely to lower even after it has been stored.

Moreover, in a case where the addition amount of polycyclic hydrocarbon compound is sufficiently less (in a case where it is 0.5% by mass or less, for instance), it is possible to inhibit the internal resistance of the resulting lithium-ion secondary batteries from rising.

### Example No. 15

<Making of Positive Electrode>

The following were mixed one another in a proportion of 88:6:6 by mass ratio: a positive-electrode active material being obtained in the same manner as Example No. 1; acetylene black serving as a conductive additive; and polyvinylidene fluoride (or PVdF) serving as a binder resin. Subsequently, this slurry was coated onto a 20-μm-thickness aluminum foil, namely, a current collector, using a doctor blade, thereby forming a positive-electrode active-material layer on the aluminum foil. Thereafter, the slurry on the aluminum foil was vacuum dried at 120° C. for 12 hours or more, and was then made into an electrode, namely, a positive electrode with 30×25 mm.

<Making of Negative Electrode>

With 42 parts by mass of an SiOₓ powder being obtained in the same manner as Example No. 1, the following were mixed: 40-part-by-mass “MAG” powder and 3-part-by-mass KETJENBLACK (or KB) powder serving as a conductive additive, respectively; and polyamide-imide serving as a binding resin, thereby preparing a slurry. A compositional ratio between the respective components within the resulting slurry was the SiOₓ powder: the “MAG” powder: KETJENBLACK: the polyamide-imide=42:40:3:15 when being taken respectively as the solid content. This slurry was coated onto a surface of a 20-μm-thickness electrolytic copper foil, namely, a current collector, using a doctor blade, thereby forming a negative-electrode active-material layer on the copper foil.

<Making of Lithium-Ion Secondary Battery>

LiPF₆ was dissolved into a mixed solvent, in which ethylene carbonate and ethyl methyl carbonate were mixed in a volumetric ratio of 3:7, so as to make a concentration of 1 M. A non-aqueous electrolytic solution was prepared by adding bis(4-methoxyphenyl)disulfide to this mixed liquid so as to make 0.01% by mass and then dissolving bis(4-methoxyphenyl)disulfide into it.

A 20-μm-thickness microporous polyethylene film serving as a separator was interposed between the positive electrode and negative electrode that have been mentioned above, thereby turning them into an electrode assembly. This electrode assembly was wrapped up with a laminated film, and was then heat fused at the circumference in order to make an externally-film-packed battery. Before sealing a final one of the sides by heat fusing, the above-mentioned electrolytic solution was injected, thereby impregnating the electrode assembly with the electrolytic solution. Thereafter, CCCV charging (i.e., constant-current constant-voltage charging) was carried out up to 4.5 V at 0.2 C in order to activate the positive-electrode active material.

### Comparative Example No. 9

Except that no additive agent was added, a lithium-ion secondary battery according to Comparative Example No. 9 was one which was otherwise identical with the lithium-ion secondary battery according to Example No. 15.

<Test>

(Calculation of Recovery Percentage of Capacity)

A high-temperature storage test, in which the above-mentioned lithium-ion secondary batteries were stored at 80° C. for 5 days, was carried out, during which the 1 C discharged capacity before the high-temperature storage test, and the 1 C discharged capacity after 100% SOC charging that followed discharging after the high-temperature storage, were measured respectively in order to calculate a recovery percentage of the capacity, respectively. The results are shown in Table 14.

TABLE 14

| | Recovery Percentage of |
|---|---|
| | Capacity (%) |
| Ex. No. 15 | 75.7 |
| Comp. Ex. No. 9 | 73.9 |

<Evaluation>

As shown in Table 14, the lithium-ion secondary battery according to Example No. 15 exhibited a recovery percentage of the capacity that had augmented, compared with that of the lithium-ion secondary battery according to Comparative Example No. 9. To be concrete, the lithium-ion secondary battery according to Example No. 15, which included 0.01%-by-mass bis(4-methoxyphenyl)disulfide in the electrolytic solution, exhibited a recovery percentage of the capacity that had augmented by 1.8%, compared with that of the lithium-ion secondary battery according to Comparative Example No. 9, which did not include any additive agent in the electrolytic solution.

From this result, it is possible to augment lithium-ion secondary batteries in terms of a recovery percentage of the capacity by adding one of the additive agents, namely, a diphenyl-disulfide-based organosulfur compound, to the electrolytic solutions. In other words, the lithium-ion secondary battery according to the present invention that includes a diphenyl-disulfide-based organo sulfur compound in the electrolytic solution exhibits charging and discharging capacities that are less likely to lower even after it has been stored.

1. An electrolytic solution being characterized in that: the electrolytic solution is used for lithium-ion secondary battery being provided with a positive electrode that has a positive-electrode active material comprising a lithium-manganese-based oxide which includes a lithium (Li) element and a tetravalent manganese (Mn) element and whose crystal structure belongs to a layered rock-salt structure, and the electrolytic solution includes an additive agent comprising at least one member of compounds that is selected from the group consisting of Compounds (a) through (i) being mentioned below:
Compound (a): chain-shaped compounds having a sultone group;
Compound (b): compounds including an oxygen-containing heterocyclic ring, a carbonyl group being formed onto one of carbon atoms lying adjacent to an oxygen atom in the oxygen-containing heterocyclic ring, and a carboxyl group being bonded onto another one of carbon atoms lying adjacent to the oxygen atom in the oxygen-containing heterocyclic ring directly or by way of an alkyl group;
Compound (c): at least one member of compounds being selected from the group consisting of thiophene and thiophene derivatives;
Compound (d): at least one member of compounds being selected from the group consisting of tert-alkylbenzene and tert-alkylbenzene derivatives;
Compound (e): at least one member of compounds being selected from the group consisting of N-alkyl pyrole and N-alkyl pyrole derivatives;
Compound (f): compounds including an oxygen-containing heterocyclic ring, and a carbonyl group being formed onto a carbon atom lying adjacent to one of oxygen atoms that constitute the oxygen-containing heterocyclic ring;
Compound (g): at least one member of compounds being selected from the group consisting of furan and furan derivatives;
Compound (h): at least one member of compounds being selected from the group consisting of polycyclic hydrocarbon compounds that are expressed by General Formula (i.e., Chemical Formula 1) being mentioned below, and derivatives thereof; and 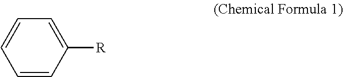
Compound (i): at least one member of compounds being selected from the group consisting of organosulfur compounds, which are made by bonding an alkoxy group onto at least one of carbon (C) atoms being included in a basic skeleton that comprises diphenyl disulfide, and derivatives of the organosulfur compounds.

2. The electrolytic solution as set forth in claim 1, wherein said Compound (a) includes two pieces of said sultone groups, and is added in an amount of less than 1.0% by mass within said electrolytic solution.

3. The electrolytic solution as set forth in claim 2, said Compound (a) is 2,3-butanediol-dimethanesulfonate.

4. The electrolytic solution as set forth in claim 1, wherein said Compound (b) is 2-pyrone-4,6-dicarboxylic acid, and is added in an amount of less than 2.0% by mass within said electrolytic solution.

5. The electrolytic solution as set forth in claim 1, wherein said Compound (c) is thiophene, and is added in an amount of less than 2.0% by mass within said electrolytic solution.

6. The electrolytic solution as set forth in claim 1, wherein said Compound (d) is tert-butylbenzene, and is added in an amount of from 1.0% by mass or more to less than 3.0% by mass within said electrolytic solution.

7. The electrolytic solution as set forth in claim 1, wherein said Compound (d) is tert-pentylbenzene, and is added in an amount of from 1.0% by mass or more to less than 3.0% by mass within said electrolytic solution.

8. The electrolytic solution as set forth in claim 1, wherein said Compound (e) is N-alkyl pyrole, and is added in an amount of less than 2.0% by mass within said electrolytic solution.

9. The electrolytic solution as set forth in claim 1, wherein said Compound (f) is at least one member that is selected from the group consisting of γ-butyrolactone, γ-butyrolactone being provided with a substituent group, δ-valerolactone, δ-valerolactone being provided with a substituent group, and α-pyrone.

10. The electrolytic solution as set forth in claim 1, wherein said Compound (f) is γ-butyrolactone, and is added in a range of 0.1% by mass or more, or less than 5% by mass, within said electrolytic solution.

11. The electrolytic solution as set forth in claim 1, wherein said Compound (g) is furan, and is added in an amount of less than 2.0% by mass within said electrolytic solution.

12. The electrolytic solution as set forth in claim 1, wherein said Compound (h) is added in a range of 0.01% by mass or more, or 1% by mass or less, within said electrolytic solution.

13. The electrolytic solution as set forth in claim 1, wherein said Compound (h) is added in a range of 0.05% by mass or more, or 0.5% by mass or less, within said electrolytic solution.

14. The electrolytic solution as set forth in claim 1, wherein said Compound (h) is biphenyl.

15. The electrolytic solution as set forth in claim 1, wherein said Compound (h) is cyclohexylbenzene.

16. The electrolytic solution as set forth in claim 1, wherein said Compound (i) is bis(alkoxyphenyl)disulfide.

17. The electrolytic solution as set forth in claim 1, wherein said Compound (i) is bis(4-methoxyphenyl)disulfide.

18. The electrolytic solution as set forth in claim 1, wherein said Compound (i) is bis(3-methoxyphenyl)disulfide.

19. The electrolytic solution as set forth in claim 1, wherein said Compound (i) is added in a range of 0.001% by mass or more, or 0.5% by mass or less, within said electrolytic solution.

20. A lithium-ion secondary battery being characterized in that the lithium-ion secondary battery comprises:
a positive electrode having a positive-electrode active material that comprises a lithium-manganese-based oxide which includes a lithium (Li) element and a tetravalent manganese (Mn) element and whose crystal structure belongs to a layered rock-salt structure;
a negative electrode; and
the electrolytic solution being set forth in claim 1.

21. The lithium-ion secondary battery as set forth in claim 20, wherein said lithium-manganese-based oxide is Li₂MnO₃.

22. The lithium-ion secondary battery as set forth in claim 20, wherein said negative electrode includes a negative-electrode active material comprising an oxide of silicon that is expressed by SiOₓ (where 0.3≦“x”≦1.6).

23. A vehicle being characterized in that the vehicle has the lithium-ion secondary battery as set forth in claim 20 on-board.
